(19) United States
(12) Patent Application Publication
(10) Pub. No.: US 2026/0186384 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventor: Haichao Peng, Changzhou (CN)

(21) Appl. No.: 19/317,186

(22) Filed: Sep. 3, 2025

Related U.S. Application Data
(63) Continuation of application No. PCT/CN2024/144638, filed on Dec. 31, 2024.

(51) Int. Cl. G03B 17/17; G02B 9/60

(52) U.S. Cl. CPC G03B 17/17; G02B 9/60

(57) ABSTRACT

Provided is a camera optical lens, including in sequence from an object side to an image side: a first prism with a positive refractive power, a first lens with a positive refractive power, a second lens with a positive refractive power, a third lens with a negative refractive power, a fourth lens with a positive refractive power, and a fifth lens. The first lens, the second lens, the third lens, and the fourth lens form a first lens group, and the first lens group is movably adjustable along an optical axis of the camera optical lens, enabling the camera optical lens to switch between a first state and a second state. The camera optical lens satisfies: 4.00≤fA/IH≤6.20, where fA represents a focal length of the camera optical lens in the first state, and JH represents an image height of the camera optical lens.

### CROSS REFERENCE TO RELATED APPLICATIONS

The present disclosure is a continuation of PCT Patent Application No. PCT/CN2024/144638, filed Dec. 31, 2024, which is incorporated by reference herein in its entirety.

### TECHNICAL FIELD

Embodiments of the present disclosure relate to the technical field of optics, and in particular, to a camera optical lens.

### BACKGROUND

With the rapid development and widespread adoption of smartphones, the research, development, and design of camera lenses have advanced swiftly. Combined with the current trend toward electronic products featuring superior functionality and thin, light, and compact form factors, miniaturized camera lenses with high imaging quality have become the mainstream in the market.

Telephoto camera lenses can meet consumer demand for photographing specific targets. Traditional telephoto camera lenses have an excessively large total track length, failing to satisfy the thin and light design requirements of smartphones. In contrast, designs of periscope-type telephoto camera lenses can significantly shorten the total track length of camera lenses while meeting telephoto design requirements. Nevertheless, the optical performance of existing periscope-type telephoto camera lenses still cannot meet requirements.

### SUMMARY

Embodiments of the present disclosure provide a camera optical lens, which can meet moving focusing, realize a large-aperture periscope design, and has good optical performance.

In order to solve the above technical problems, a first aspect of the present disclosure provides a camera optical lens. The camera optical lens includes in sequence from an object side to an image side: a first prism with a positive refractive power, a first lens with a positive refractive power, a second lens with a positive refractive power, a third lens with a negative refractive power, a fourth lens with a positive refractive power, and a fifth lens. A reflective surface is provided between an object-side surface and an image-side surface of the first prism, the first lens, the second lens, the third lens, and the fourth lens form a first lens group, the fifth lens forms a second lens group, and the first lens group is movably adjustable along an optical axis of the camera optical lens, enabling the camera optical lens to switch between a first state and a second state. The camera optical lens has a maximum focal length in the first state and a minimum focal length in the second state, and satisfies the following conditions: 4.00≤fA/IH≤6.20; −4.00≤Rp1/Rp2≤0.75; −0.35≤f4/f5≤0.20; and 0.12≤BF/Lp≤1.00, where fA represents a focal length of the camera optical lens in the first state, IH represents an image height of the camera optical lens, Rp1 represents a curvature radius of the object-side surface of the first prism, Rp2 represents a curvature radius of the image-side surface of the first prism, f4 represents a focal length of the fourth lens, f5 represents a focal length of the fifth lens, BF represents a back focal length of the camera optical lens, and Lp represents a distance from a lens surface closest to the object side to a lens surface closest to the image side on the optical axis of the camera optical lens in the first state.

As an improvement, the camera optical lens further satisfies the following conditions: 0.17≤d1/Lp≤0.50, 0.11≤d3/Lp≤0.31, and 0.04≤d5/Lp≤0.30, where d1 represents an on-axis thickness of the first lens, d3 represents an on-axis thickness of the second lens, and d5 represents an on-axis thickness of the third lens.

As an improvement, the object-side surface of the first prism is a curved surface and is convex in a paraxial region, and the camera optical lens further satisfies the following conditions: 2.55≤fp1/fA≤122.03, and 0.20≤dp1/TTL≤0.28, where fp1 represents a focal length of the first prism, dp1 represents a sum of an on-axis distance from the object-side surface of the first prism to the reflective surface and an on-axis distance from the reflective surface to the image-side surface of the first prism, and TTL represents a total track length of the camera optical lens.

As an improvement, an object-side surface of the first lens is concave in a paraxial region, an image-side surface of the first lens is convex in the paraxial region, and the camera optical lens further satisfies the following conditions: 3.08≤(R1+R2)/(R1−R2)≤4.50, 0.55≤f1/fA≤1.16, and 0.04≤d1/TTL≤0.18, where R1 represents a curvature radius of the object-side surface of the first lens, R2 represents a curvature radius of the image-side surface of the first lens, f1 represents a focal length of the first lens, d1 represents an on-axis thickness of the first lens, and TTL represents a total track length of the camera optical lens.

As an improvement, an object-side surface of the second lens is convex in a paraxial region, an image-side surface of the second lens is convex in the paraxial region, and the camera optical lens further satisfies the following conditions: 0.80≤(R3+R4)/(R3−R4)≤0.96, 0.26≤f2/fA≤0.35, and 0.03≤d3/TTL≤0.08, where R3 represents a curvature radius of the object-side surface of the second lens, R4 represents a curvature radius of the image-side surface of the second lens, f2 represents a focal length of the second lens, d3 represents an on-axis thickness of the second lens, and TTL represents a total track length of the camera optical lens.

As an improvement, an object-side surface of the third lens is concave in a paraxial region, an image-side surface of the third lens is concave in the paraxial region, and the camera optical lens further satisfies the following conditions: −0.35≤(R5+R6)/(R5−R6)≤0.57, −0.23≤f3/fA≤−0.15, and 0.01≤d5/TTL≤0.08, where R5 represents a curvature radius of the object-side surface of the third lens, R6 represents a curvature radius of the image-side surface of the third lens, f3 represents a focal length of the third lens, d5 represents an on-axis thickness of the third lens, and TTL represents a total track length of the camera optical lens.

As an improvement, an object-side surface of the fourth lens is convex in a paraxial region, an image-side surface of the fourth lens is convex in the paraxial region, and the camera optical lens further satisfies the following conditions: 0.09≤(R7+R8)/(R7−R8)≤0.93, 0.58≤f4/fA≤1.61, and 0.02≤d7/TTL≤0.08, where R7 represents a curvature radius of the object-side surface of the fourth lens, R8 represents a curvature radius of the image-side surface of the fourth lens, f4 represents a focal length of the fourth lens, d7 represents an on-axis thickness of the fourth lens, and TTL represents a total track length of the camera optical lens.

As an improvement, an object-side surface of the fifth lens is convex in a paraxial region, an image-side surface of the fifth lens is concave in the paraxial region, and the camera optical lens further satisfies the following conditions: −32.34≤(R9+R10)/(R9−R10)≤177.34, −27.24≤f5/fA≤24.47, and 0.15≤d9/TTL≤0.23, where R9 represents a curvature radius of the object-side surface of the fifth lens, R10 represents a curvature radius of the image-side surface of the fifth lens, f5 represents a focal length of the fifth lens, d9 represents an on-axis thickness of the fifth lens, and TTL represents a total track length of the camera optical lens.

As an improvement, the first prism is made of glass.

Beneficial effects of the present disclosure are as follows. A prism and lenses are combined to form the camera optical lens. Five lenses are divided into two groups. A front group performs movable focusing, enabling faster and smoother focusing processes. At the same time, a physical length of the camera optical lens remains unchanged, facilitating internal space allocation of the device. The camera optical lens satisfying the conditions achieves a longer focal length under a fixed image height, facilitating the increase of system magnification. Deflection of light rays entering the lens is mitigated, facilitating subsequent smooth propagation. Reasonable distribution of the optical focal power of adjacent lenses in the system facilitates gentle transition of light rays, improving imaging quality. A long back focal length facilitates module assembly, and a total track length of the optical system can be effectively controlled.

### BRIEF DESCRIPTION OF THE DRAWINGS

In order to more clearly illustrate the technical solutions of the embodiments of the present disclosure or the prior art, the drawings used in the description of the embodiments or the prior art will be briefly introduced below. It is obvious that the drawings described below are only some embodiments of the present disclosure. For those skilled in the art, other drawings may also be obtained based on these drawings without creative efforts.

FIG. 1A is a schematic structural diagram of a camera optical lens according to a first embodiment of the present disclosure in a first state;

FIG. 1B is a schematic structural diagram of the camera optical lens according to the first embodiment of the present disclosure in a second state;

FIG. 2A is a diagram illustrating field curvature and distortion of the camera optical lens shown in FIG. 1A;

FIG. 2B is a diagram illustrating field curvature and distortion of the camera optical lens shown in FIG. 1B;

FIG. 3A is a diagram illustrating longitudinal aberration of the camera optical lens shown in FIG. 1A;

FIG. 3B is a diagram illustrating longitudinal aberration of the camera optical lens shown in FIG. 1B;

FIG. 4A is a diagram illustrating lateral color of the camera optical lens shown in FIG. 1A;

FIG. 4B is a diagram illustrating lateral color of the camera optical lens shown in FIG. 1B;

FIG. 5A is a schematic structural diagram of a camera optical lens according to a second embodiment of the present disclosure in a first state;

FIG. 5B is a schematic structural diagram of the camera optical lens according to the second embodiment of the present disclosure in a second state;

FIG. 6A is a diagram illustrating field curvature and distortion of the camera optical lens shown in FIG. 5A;

FIG. 6B is a diagram illustrating field curvature and distortion of the camera optical lens shown in FIG. 5B;

FIG. 7A is a diagram illustrating longitudinal aberration of the camera optical lens shown in FIG. 5A;

FIG. 7B is a diagram illustrating longitudinal aberration of the camera optical lens shown in FIG. 5B;

FIG. 8A is a diagram illustrating lateral color of the camera optical lens shown in FIG. 5A;

FIG. 8B is a diagram illustrating lateral color of the camera optical lens shown in FIG. 5B;

FIG. 9A is a schematic structural diagram of a camera optical lens according to a third embodiment of the present disclosure in a first state;

FIG. 9B is a schematic structural diagram of the camera optical lens according to the third embodiment of the present disclosure in a second state;

FIG. 10A is a diagram illustrating field curvature and distortion of the camera optical lens shown in FIG. 9A;

FIG. 10B is a diagram illustrating field curvature and distortion of the camera optical lens shown in FIG. 9B;

FIG. 11A is a diagram illustrating longitudinal aberration of the camera optical lens shown in FIG. 9A;

FIG. 11B is a diagram illustrating longitudinal aberration of the camera optical lens shown in FIG. 9B;

FIG. 12A is a diagram illustrating lateral color of the camera optical lens shown in FIG. 9A;

FIG. 12B is a diagram illustrating lateral color of the camera optical lens shown in FIG. 9B;

FIG. 13A is a schematic structural diagram of a camera optical lens according to a fourth embodiment of the present disclosure in a first state;

FIG. 13B is a schematic structural diagram of the camera optical lens according to the fourth embodiment of the present disclosure in a second state;

FIG. 14A is a diagram illustrating field curvature and distortion of the camera optical lens shown in FIG. 13A;

FIG. 14B is a diagram illustrating field curvature and distortion of the camera optical lens shown in FIG. 13B;

FIG. 15A is a diagram illustrating longitudinal aberration of the camera optical lens shown in FIG. 13A;

FIG. 15B is a diagram illustrating longitudinal aberration of the camera optical lens shown in FIG. 13B;

FIG. 16A is a diagram illustrating lateral color of the camera optical lens shown in FIG. 13A;

FIG. 16B is a diagram illustrating lateral color of the camera optical lens shown in FIG. 13B;

FIG. 17A is a schematic structural diagram of a camera optical lens according to a fifth embodiment of the present disclosure in a first state;

FIG. 17B is a schematic structural diagram of the camera optical lens according to the fifth embodiment of the present disclosure in a second state;

FIG. 18A is a diagram illustrating field curvature and distortion of the camera optical lens shown in FIG. 17A;

FIG. 18B is a diagram illustrating field curvature and distortion of the camera optical lens shown in FIG. 17B;

FIG. 19A is a diagram illustrating longitudinal aberration of the camera optical lens shown in FIG. 17A;

FIG. 19B is a diagram illustrating longitudinal aberration of the camera optical lens shown in FIG. 17B;

FIG. 20A is a diagram illustrating lateral color of the camera optical lens shown in FIG. 17A;

FIG. 20B is a diagram illustrating lateral color of the camera optical lens shown in FIG. 17B;

FIG. 21A is a schematic structural diagram of a camera optical lens according to a sixth embodiment of the present disclosure in a first state;

FIG. 21B is a schematic structural diagram of the camera optical lens according to the sixth embodiment of the present disclosure in a second state;

FIG. 22A is a diagram illustrating field curvature and distortion of the camera optical lens shown in FIG. 21A;

FIG. 22B is a diagram illustrating field curvature and distortion of the camera optical lens shown in FIG. 21B;

FIG. 23A is a diagram illustrating longitudinal aberration of the camera optical lens shown in FIG. 21A;

FIG. 23B is a diagram illustrating longitudinal aberration of the camera optical lens shown in FIG. 21B;

FIG. 24A is a diagram illustrating lateral color of the camera optical lens shown in FIG. 21A;

FIG. 24B is a diagram illustrating lateral color of the camera optical lens shown in FIG. 21B;

FIG. 25A is a schematic structural diagram of a camera optical lens according to a seventh embodiment of the present disclosure in a first state;

FIG. 25B is a schematic structural diagram of the camera optical lens according to the seventh embodiment of the present disclosure in a second state;

FIG. 26A is a diagram illustrating field curvature and distortion of the camera optical lens shown in FIG. 25A;

FIG. 26B is a diagram illustrating field curvature and distortion of the camera optical lens shown in FIG. 25B;

FIG. 27A is a diagram illustrating longitudinal aberration of the camera optical lens shown in FIG. 25A;

FIG. 27B is a diagram illustrating longitudinal aberration of the camera optical lens shown in FIG. 25B;

FIG. 28A is a diagram illustrating lateral color of the camera optical lens shown in FIG. 25A;

FIG. 28B is a diagram illustrating lateral color of the camera optical lens shown in FIG. 25B;

FIG. 29A is a schematic structural diagram of a camera optical lens according to an eighth embodiment of the present disclosure in a first state;

FIG. 29B is a schematic structural diagram of the camera optical lens according to the eighth embodiment of the present disclosure in a second state;

FIG. 30A is a diagram illustrating field curvature and distortion of the camera optical lens shown in FIG. 29A;

FIG. 30B is a diagram illustrating field curvature and distortion of the camera optical lens shown in FIG. 29B;

FIG. 31A is a diagram illustrating longitudinal aberration of the camera optical lens shown in FIG. 29A;

FIG. 31B is a diagram illustrating longitudinal aberration of the camera optical lens shown in FIG. 29B;

FIG. 32A is a diagram illustrating lateral color of the camera optical lens shown in FIG. 29A;

FIG. 32B is a diagram illustrating lateral color of the camera optical lens shown in FIG. 29B;

FIG. 33A is a schematic structural diagram of a camera optical lens according to a ninth embodiment of the present disclosure in a first state;

FIG. 33B is a schematic structural diagram of the camera optical lens according to the ninth embodiment of the present disclosure in a second state;

FIG. 34A is a diagram illustrating field curvature and distortion of the camera optical lens shown in FIG. 33A;

FIG. 34B is a diagram illustrating field curvature and distortion of the camera optical lens shown in FIG. 33B;

FIG. 35A is a diagram illustrating longitudinal aberration of the camera optical lens shown in FIG. 33A;

FIG. 35B is a diagram illustrating longitudinal aberration of the camera optical lens shown in FIG. 33B;

FIG. 36A is a diagram illustrating lateral color of the camera optical lens shown in FIG. 33A; and

FIG. 36B is a diagram illustrating lateral color of the camera optical lens shown in FIG. 33B.

### DETAILED DESCRIPTION OF THE EMBODIMENTS

To make the objects, technical solutions, and advantages of the present disclosure clearer, embodiments of the present disclosure are described in detail with reference to accompanying drawings in the following. A person of ordinary skill in the art can understand that, in the embodiments of the present disclosure, many technical details are provided to make readers better understand the present disclosure. However, even without these technical details and any changes and modifications based on the following embodiments, technical solutions required to be protected by the present disclosure can be implemented.

Referring to the drawings, the technical solutions of the present disclosure provides a camera optical lens 10, 20, 30, 40, 50, 60, 70, 80, 90. The camera optical lens 10, 20, 30, 40, 50, 60, 70, 80, 90 includes a first prism P1 with a positive refractive power, a first lens L1 with a positive refractive power, a second lens L2 with a positive refractive power, a third lens L3 with a negative refractive power, a fourth lens L4 with a positive refractive power, and a fifth lens L5 arranged in sequence from an object side to an image side. A reflective surface RF is provided between an object-side surface and an image-side surface of the first prism P1. The first lens L1, second lens L2, third lens L3, and fourth lens L4 form a first lens group. The first lens group is movably adjustable along an optical axis of the camera optical lens 10, 20, 30, 40, 50, 60, 70, 80, 90, enabling the camera optical lens 10, 20, 30, 40, 50, 60, 70, 80, 90 to switch between a first state and a second state. The camera optical lens 10, 20, 30, 40, 50, 60, 70, 80, 90 has a maximum focal length in the first state and a minimum focal length in the second state.

The camera optical lens 10, 20, 30, 40, 50, 60, 70, 80, 90 has a focal length fA in the first state, and an image height IH. The object-side surface of the first prism P1 has a curvature radius Rp1, and the image-side surface of the first prism P1 has a curvature radius Rp2. The fourth lens L4 has a focal length f4, the fifth lens L5 has a focal length f5, and the camera optical lens 10, 20, 30, 40, 50, 60, 70, 80, 90 has a back focal length BF. The camera optical lens 10, 20, 30, 40, 50, 60, 70, 80, 90 has a distance Lp from a lens surface closest to the object side to a lens surface closest to the image side on the optical axis in the first state, and satisfies the following conditions:

$$4. \leq fA / IH \leq 6.2 \qquad ( 1 )$$

$$- 4. \leq Rp 1 / Rp 2 \leq 0.75 \qquad ( 2 )$$

$$- 0.35 \leq f 4 / f 5 \leq 0.2 \qquad ( 3 )$$

$$0.12 \leq BF / Lp \leq 1. \qquad ( 4 )$$

The camera optical lens 10, 20, 30, 40, 50, 60, 70, 80, 90 is a periscope-type optical lens with five lens elements. The camera optical lens 10, 20, 30, 40, 50, 60, 70, 80, 90 includes a first prism P1, a first lens L1, a second lens L2, a third lens L3, a fourth lens L4, and a fifth lens L5 arranged in sequence from the object side to the image side.

The five lens elements of the camera optical lens 10, 20, 30, 40, 50, 60, 70, 80, 90 are the first lens L1, second lens L2, third lens L3, fourth lens L4, and fifth lens L5, respectively. The five lens elements are divided into two groups: a front group (i.e., a first lens group) and a rear group (i.e., a second lens group), where the first four lenses form the front group and the last lens forms a rear group. The first lens group is closer to the object side than the second lens group.

The first lens group (i.e., the front group) is composed of the first lens L1, second lens L2, third lens L3, and fourth lens L4. An object-side surface of the first lens group is an object-side surface of the first lens L1. An image-side surface of the first lens group is an image-side surface of the fourth lens L4. The second lens group (i.e., the rear group) is composed of the fifth lens L5. An object-side surface of the second lens group is an object-side surface of the fifth lens L5. An image-side surface of the second lens group is an image-side surface of the fifth lens L5. The front group including the first lens L1, second lens L2, third lens L3, and fourth lens L4 is movable for focusing. During focusing, the process is faster and smoother. In addition, the physical length of the camera optical lens 10, 20, 30, 40, 50, 60, 70, 80, 90 can remain unchanged, facilitating internal space allocation of the device.

The first lens group is located between the first prism P1 and the second lens group, and is movable along the optical axis of the camera optical lens 10, 20, 30, 40, 50, 60, 70, 80, 90, enabling adjustment of an on-axis distance from the image-side surface of the first prism P1 to the object-side surface of the first lens group and an on-axis distance from the image-side surface of the first lens group to the object-side surface of the second lens group. Thus, the first lens group is a movable zoom group, and the second lens group is a fixed focal length group. By moving the first lens group, the focal length of the camera optical lens 10, 20, 30, 40, 50, 60, 70, 80, 90 can be changed, enabling the camera optical lens 10, 20, 30, 40, 50, 60, 70, 80, 90 to achieve good imaging effects in both the first state and the second state. The first state is a state where the focal length of the camera optical lens 10, 20, 30, 40, 50, 60, 70, 80, 90 is maximum, and the second state is a state where the focal length of the camera optical lens 10, 20, 30, 40, 50, 60, 70, 80, 90 is minimum. For example, the first state may be a telephoto state or a state with an infinite object distance, and the second state may be a short-focus state or a macro state, or a state with an object distance of 200 mm. In this way, internal focusing of the camera optical lens 10, 20, 30, 40, 50, 60, 70, 80, 90 can be achieved by moving the front group for focusing.

The condition (1) specifies a range of a ratio of the focal length fA to the image height IH of the camera optical lens 10, 20, 30, 40, 50, 60, 70, 80, 90 in the first state. Within the range defined by the condition (1), the camera optical lens 10, 20, 30, 40, 50, 60, 70, 80, 90 achieves a longer focal length under a fixed image height IH, facilitating increasing the magnification of the camera optical lens 10, 20, 30, 40, 50, 60, 70, 80, 90.

The condition (2) specifies a range of a ratio of the curvature radius Rp1 of the object-side surface of the first prism P1 to the curvature radius Rp2 of the image-side surface of the first prism P1, controlling shapes of the object-side surface and image-side surface of the first prism P1. The range defined by the condition (2) facilitates mitigating deflection of light rays entering the lens and facilitates subsequent smooth propagation of the light rays.

The condition (3) specifies a range of a ratio of the focal length of the fourth lens L4 to the focal length of the fifth lens L5. By reasonably distributing optical focal lengths of adjacent lenses of the camera optical lens 10, 20, 30, 40, 50, 60, 70, 80, 90, the range defined by the condition (3) facilitates smooth transition of light rays, improving image quality.

The condition (4) specifies a range of a ratio of the back focal length of the camera optical lens 10, 20, 30, 40, 50, 60, 70, 80, 90 to the distance from the lens surface closest to the object side to the lens surface closest to the image side on the optical axis of the camera optical lens 10, 20, 30, 40, 50, 60, 70, 80, 90 in the first state. Within the range defined by the condition (4), a longer back focal length facilitates module assembly, and the total track length of the camera optical lens 10, 20, 30, 40, 50, 60, 70, 80, 90 can be effectively controlled.

Under satisfaction of the above conditions, by dividing the five lens elements into the first lens group and the second lens group and moving the first lens group for focusing, the internal focusing of the camera optical lens 10, 20, 30, 40, 50, 60, 70, 80, 90 is achieved; by setting the ratio of the focal length to the image height of the camera optical lens 10, 20, 30, 40, 50, 60, 70, 80, 90, the camera optical lens 10, 20, 30, 40, 50, 60, 70, 80, 90 has a longer focal length under a fixed image height IH, facilitating increasing the magnification of the camera optical lens 10, 20, 30, 40, 50, 60, 70, 80, 90; configuring the concave-convex shape of the first prism P1 facilitates mitigating deflection of light rays passing through the first prism P1; by reasonably distributing the optical focal length of the camera optical lens 10, 20, 30, 40, 50, 60, 70, 80, 90, the camera optical lens 10, 20, 30, 40, 50, 60, 70, 80, 90 achieves better imaging quality and lower sensitivity; and by controlling the back focal length of the camera optical lens 10, 20, 30, 40, 50, 60, 70, 80, 90, the total track length of the camera optical lens 10, 20, 30, 40, 50, 60, 70, 80, 90 can be effectively controlled.

Based on the above conditions and achievable functions, characteristics of each lens are further detailed as follows.

Preferably, the first lens L1 has an on-axis thickness d1, the second lens L2 has an on-axis thickness d3, the third lens L3 has an on-axis thickness d5, and the following conditions are satisfied:

$$0.17 \leq d 1 / Lp \leq 0.5 \qquad ( 5 )$$

$$0.11 \leq d 3 / Lp \leq 0.31 \qquad ( 6 )$$

$$0.04 \leq d 5 / Lp \leq 0.30 \qquad ( 7 )$$

The condition (5) specifies a range of a ratio of the on-axis thickness of the first lens L1 to the distance from the lens surface closest to the object side to the lens surface closest to the image side on the optical axis of the camera optical lens 10, 20, 30, 40, 50, 60, 70, 80, 90 in the first state. Under this constraint, by controlling the on-axis thickness of the first lens L1, the dimension of the lens in the focusing group can be reasonably designed, and the total track length of the camera optical lens 10, 20, 30, 40, 50, 60, 70, 80, 90 can be effectively controlled.

The condition (6) specifies a range of a ratio of the on-axis thickness of the second lens L2 to the distance from the lens surface closest to the object side to the lens surface closest to the image side on the optical axis of the camera optical lens 10, 20, 30, 40, 50, 60, 70, 80, 90 in the first state. Under this constraint, by controlling the on-axis thickness of the second lens L2, the dimension of the lens in the focusing group can be reasonably designed, and the total track length of the camera optical lens 10, 20, 30, 40, 50, 60, 70, 80, 90 can be effectively controlled.

The condition (7) specifies a range of a ratio of the on-axis thickness of the third lens L3 to the distance from the lens surface closest to the object side to the lens surface closest to the image side on the optical axis of the camera optical lens 10, 20, 30, 40, 50, 60, 70, 80, 90 in the first state. Under this constraint, by controlling the on-axis thickness of the second lens L2, the dimension of the lens in the focusing group can be reasonably designed, and the total track length of the camera optical lens 10, 20, 30, 40, 50, 60, 70, 80, 90 can be effectively controlled.

The object-side surface of the first prism P1 is convex in a paraxial region, and the image-side surface of the first prism P1 is convex, concave or flat in the paraxial region. The object-side surface of the first prism P1 may also be configured in another surface arrangement.

Preferably, the first prism P1 has a focal length fp1, a sum of an on-axis distance from the object-side surface of the first prism P1 to the reflective surface and an on-axis distance from the reflective surface to the image-side surface of the first prism P1 is defined as dp1, the camera optical lens 10, 20, 30, 40, 50, 60, 70, 80, 90 has a total track length TTL, and the following conditions are satisfied:

$$2.55 \leq fp 1 / fA \leq 12 \; 2 \text{.03} \qquad ( 8 )$$

$$0.2 \leq dp 1 / TTL \leq 0.28 \qquad ( 9 )$$

The condition (8) specifies a range of a ratio of the focal length fp1 of the first prism P1 to the focal length fA of the camera optical lens 10, 20, 30, 40, 50, 60, 70, 80, 90 in the first state. Within this range, the first prism P1 has an appropriate positive refractive power, facilitating reduction of system aberrations and facilitating development of the camera optical lens toward miniaturization and telephoto capabilities.

The condition (9) specifies a range of a ratio of an on-axis thickness dp1 of the first prism P1 to the total track length TTL of the camera optical lens 10, 20, 30, 40, 50, 60, 70, 80, 90. Within this range, miniaturization design of the camera optical lens 10, 20, 30, 40, 50, 60, 70, 80, 90 is facilitated.

The object-side surface of the first lens L1 is concave in a paraxial region, and the image-side surface of the first lens L1 is convex in the paraxial region. The object-side surface and image-side surface of the first prism P1 may also be configured in other concave and convex arrangements.

The object-side surface of the first lens L1 has a curvature radius R1, the image-side surface of the first lens L1 has a curvature radius R2, the first lens L1 has a focal length f1, the first lens L1 has an on-axis thickness d1, the camera optical lens 10, 20, 30, 40, 50, 60, 70, 80, 90 has a total track length TTL, and the following conditions are satisfied:

$$3.08 \leq ( R 1 + R 2 ) / ( R 1 - R 2 ) \leq 4.5 \qquad ( 10 )$$

$$0.55 \leq f 1 / fA \leq 1.16 \qquad ( 11 )$$

$$0.04 \leq d 1 / TTL \leq 0.18 \qquad ( 12 )$$

The condition (10) specifies a shape of the first lens L1. Within the defined range, as the camera optical lens 10, 20, 30, 40, 50, 60, 70, 80, 90 develops toward miniaturization, correction of axial chromatic aberration is facilitated.

The condition (11) specifies a range of a ratio of the focal length f1 of the first lens L1 to the focal length fA of the camera optical lens 10, 20, 30, 40, 50, 60, 70, 80, 90 in the first state. Within this range, improvement of the optical performance of the camera optical lens 10, 20, 30, 40, 50, 60, 70, 80, 90 is facilitated.

The condition (12) specifies a range of a ratio of the on-axis thickness d1 of the first lens L1 to the total track length TTL of the camera optical lens 10, 20, 30, 40, 50, 60, 70, 80, 90. Within the defined range, miniaturization design is facilitated.

The object-side surface of the second lens L2 is convex in a paraxial region, and the image-side surface of the second lens L2 is convex in the paraxial region. The object-side surface and image-side surface of the second lens L2 may also be configured in other concave and convex arrangements.

Preferably, the object-side surface of the second lens L2 has a curvature radius R3, the image-side surface of the second lens L2 has a curvature radius R4, the second lens L2 has a focal length f2, the second lens L2 has an on-axis thickness d3, the camera optical lens 10, 20, 30, 40, 50, 60, 70, 80, 90 has a total track length TTL, and the following conditions are satisfied:

$$0.8 \leq ( R 3 + R 4 ) / ( R 3 - R 4 ) \leq 0.96 \qquad ( 13 )$$

$$0. 26 \leq f 2 / fA \leq 0.35 \qquad ( 14 )$$

$$0.03 \leq d 3 / TTL \leq 0.08 \qquad ( 15 )$$

The condition (13) specifies a shape of the second lens L2, effectively controlling the shape of the second lens L2 and facilitating molding of the second lens L2. Within the range defined by the condition (13), deflection of light rays passing through the lens can be mitigated, effectively reducing aberrations.

The condition (14) specifies a range of a ratio of the focal length f2 of the second lens L2 to the focal length fA of the camera optical lens 10, 20, 30, 40, 50, 60, 70, 80, 90 in the first state. Within this range, reasonable distribution of the optical focal power enables the system to achieve better imaging quality and lower sensitivity.

The condition (15) specifies a range of a ratio of the on-axis thickness d3 of the second lens L2 to the total track length TTL of the camera optical lens 10, 20, 30, 40, 50, 60, 70, 80, 90. Within the range defined by the above condition (15), miniaturization design of the camera optical lens 10, 20, 30, 40, 50, 60, 70, 80, 90 is facilitated.

The object-side surface of the third lens L3 is concave in a paraxial region, and the image-side surface of the third lens L3 is concave in the paraxial region. The object-side surface and image-side surface of the third lens L3 may also be configured in other concave and convex arrangements.

Preferably, the object-side surface of the third lens L3 has a curvature radius R5, the image-side surface of the third lens L3 has a curvature radius R6, the third lens L3 has a focal length f3, the third lens L3 has an on-axis thickness d5, the camera optical lens 10, 20, 30, 40, 50, 60, 70, 80, 90 has a total track length TTL, and the following conditions are satisfied:

$$- 0.35 \leq ( R 5 + R 6 ) / ( R 5 - R 6 ) \leq 0.57 \qquad ( 16 )$$

$$- 0.23 \leq f 3 / fA \leq - 0.15 \qquad ( 17 )$$

$$0.01 \leq d 5 / TTL \leq 0.08 \qquad ( 18 )$$

The condition (16) specifies a shape of the third lens L3. Within the defined range, as the camera optical lens 10, 20, 30, 40, 50, 60, 70, 80, 90 develops toward miniaturization, correction of axial chromatic aberration is facilitated.

The condition (17) specifies a range of a ratio of the focal length f3 of the third lens L3 to the focal length fA of the camera optical lens 10, 20, 30, 40, 50, 60, 70, 80, 90 in the first state. Within this range, improvement of the optical performance of the camera optical lens 10, 20, 30, 40, 50, 60, 70, 80, 90 is facilitated.

The condition (18) specifies a range of a ratio of the on-axis thickness d5 of the third lens L3 to the total track length TTL of the camera optical lens 10, 20, 30, 40, 50, 60, 70, 80, 90. Within the defined range, miniaturization design of the camera optical lens 10, 20, 30, 40, 50, 60, 70, 80, 90 is facilitated.

The object-side surface of the fourth lens L4 is convex in a paraxial region, and the image-side surface of the fourth lens L4 is convex in the paraxial region. The object-side surface and image-side surface of the fourth lens L4 may also be configured in other concave and convex arrangements.

Preferably, the object-side surface of the fourth lens L4 has a curvature radius R7, the image-side surface of the fourth lens L4 has a curvature radius R8, the fourth lens L4 has a focal length f4, the fourth lens L4 has an on-axis thickness d7, the camera optical lens 10, 20, 30, 40, 50, 60, 70, 80, 90 has a total track length TTL, and the following conditions are satisfied:

$$0.09 \leq ( R 7 + R 8 ) / ( R 7 - R 8 ) \leq 0.93 \qquad ( 19 )$$

$$0.58 \leq f 4 / fA \leq 1.61 \qquad ( 20 )$$

$$0.02 \leq d 7 / TTL \leq 0.08 \qquad ( 21 )$$

The condition (19) specifies a shape of the fourth lens L4. Within the range defined by the condition (19), reasonable control of the shape of the fourth lens L4 enables effective correction of spherical aberration in the system.

The condition (20) specifies a range of a ratio of the focal length f4 of the fourth lens L4 to the focal length fA of the camera optical lens 10, 20, 30, 40, 50, 60, 70, 80, 90 in the first state. Within the range defined by the condition (20), ray angles in the camera optical lens 10, 20, 30, 40, 50, 60, 70, 80, 90 can be effectively gentled, reducing tolerance sensitivity.

The condition (21) specifies a range of a ratio of the on-axis thickness d7 of the fourth lens L4 to the total track length TTL of the camera optical lens 10, 20, 30, 40, 50, 60, 70, 80, 90. Within this range, miniaturization design of the camera optical lens 10, 20, 30, 40, 50, 60, 70, 80, 90 is facilitated.

The fifth lens L5 has a positive refractive power or a negative refractive power. The object-side surface of the fifth lens L5 is convex in a paraxial region, and the image-side surface of the fifth lens L5 is concave in the paraxial region. The object-side surface and image-side surface of the fifth lens L5 may also be configured in other concave and convex arrangements.

Preferably, the object-side surface of the fifth lens L5 has a curvature radius R9, the image-side surface of the fifth lens L5 has a curvature radius R10, the fifth lens L5 has a focal length f5, the fifth lens L5 has an on-axis thickness d9, the camera optical lens 10, 20, 30, 40, 50, 60, 70, 80, 90 has a total track length TTL, and the following conditions are satisfied:

$$- 32.34 \leq ( R 9 + R 10 ) / ( R 9 - R 10 ) \leq 1 77.34 \qquad ( 22 )$$

$$- 27.24 \leq f 5 / fA \leq 24.47 \qquad ( 23 )$$

$$0.15 \leq d 9 / TTL \leq 0.23 \qquad ( 24 )$$

The condition (22) specifies a shape of the fifth lens L5. Within this range, as the camera optical lens 10, 20, 30, 40, 50, 60, 70, 80, 90 develops toward miniaturization, correction of axial chromatic aberration is facilitated.

The condition (23) specifies a range of a ratio of the focal length f5 of the fifth lens L5 to the focal length fA of the camera optical lens 10, 20, 30, 40, 50, 60, 70, 80, 90 in the first state. Within this range, reasonable distribution of the optical focal power enables the system to achieve better imaging quality and lower sensitivity.

The condition (24) specifies a range of a ratio of the on-axis thickness d9 of the fifth lens L5 to the total track length TTL of the camera optical lens 10, 20, 30, 40, 50, 60, 70, 80, 90, facilitating miniaturization design of the camera optical lens 10, 20, 30, 40, 50, 60, 70, 80, 90.

In the present disclosure, a material of the first prism P1 is glass, and materials of the first lens L1, second lens L2, third lens L3, fourth lens L4, and fifth lens L5 are plastic. In other practicable cases, the first prism P1 and the lenses may be configured with other materials.

In the present disclosure, an optical element such as an optical filter GF is arranged between the fifth lens L5 and an imaging surface Si. The optical filter GF may be a glass cover plate or an optical filter. In other examples, the optical filter GF may also be arranged at another position.

In the present disclosure, an aperture ST may be arranged between the first prism P1 and the first lens L1.

The camera optical lens 10, 20, 30, 40, 50, 60, 70, 80, 90 of the present disclosure can achieve a large-aperture periscope design with good optical performance.

Embodiments are provided below to illustrate the camera optical lens 10, 20, 30, 40, 50, 60, 70, 80, 90 of the present disclosure. Symbols used in each embodiment are shown below. Units for focal length, on-axis distance, central curvature radius, and on-axis thickness are mm.
TTL: Total track length (an on-axis distance from the object-side surface of the first prism P1 to the imaging surface Si) in mm.
BF: Back focal length (an on-axis distance from the image-side surface of the fifth lens L5 to the imaging surface Si) in mm.

Technical solutions of the present disclosure are specifically described below through nine embodiments.

### First Embodiment

The first prism P1 has a positive refractive power, the object-side surface of the first prism P1 is convex in a paraxial region, and the image-side surface of the first prism P1 is flat in the paraxial region.

The first lens L1 has a positive refractive power, the object-side surface of the first lens L1 is concave in a paraxial region, and the image-side surface of the first lens L1 is convex in the paraxial region.

The second lens L2 has a positive refractive power, the object-side surface of the second lens L2 is convex in a paraxial region, and the image-side surface of the second lens L2 is convex in the paraxial region.

The third lens L3 has a negative refractive power, the object-side surface of the third lens L3 is concave in a paraxial region; the image-side surface of the third lens L3 is concave in the paraxial region.

The fourth lens L4 has a positive refractive power, the object-side surface of the fourth lens L4 is convex in a paraxial region; the image-side surface of the fourth lens L4 is convex in the paraxial region.

The fifth lens L5 has a positive refractive power, the object-side surface of the fifth lens L5 is convex in a paraxial region; the image-side surface of the fifth lens L5 is concave in the paraxial region.

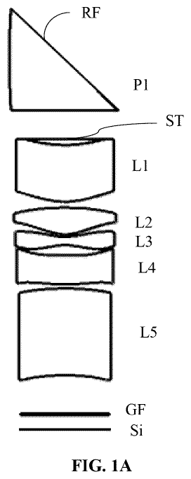

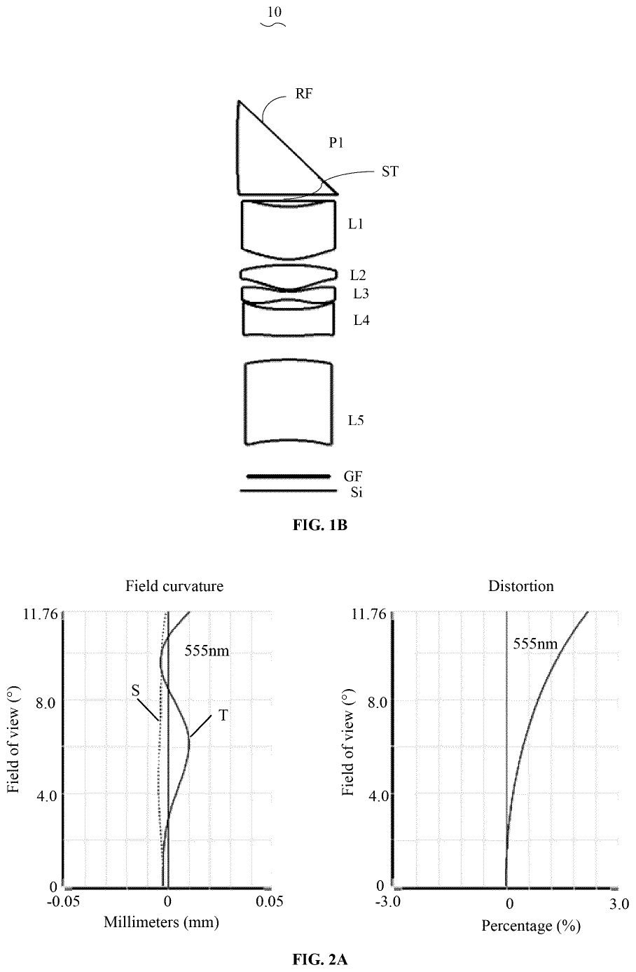

FIG. 1A and FIG. 1B are schematic structural diagrams of the camera optical lens 10 in the first embodiment. Design data of the camera optical lens 10 in the first embodiment of the present disclosure are shown below.

Table 1 lists the curvature radii R of the object-side surface and the image-side surface, the on-axis thickness of the lens, the on-axis distance d between the lenses, the refractive index nd and the Abbe number vd in the first lens L1 to the fifth lens L5 constituting the camera optical lens 10 according to the first embodiment of the present disclosure. It should be noted that units for distances, radii, and thicknesses in this embodiment are millimeters (mm).

TABLE 1

| | R | d | | nd | | vd | |
|---|---|---|---|---|---|---|---|
| ST | ∞ | d0 | d0 | / | / | / | / |
| Rp1 | 76.126 | dp1 | 9.800 | nd1 | 1.8052 | vd1 | 40.89 |
| Rp2 | ∞ | dp2 | dp2 | | | | |
| R1 | −11.266 | d1 | 5.400 | nd2 | 1.6400 | vd2 | 23.54 |
| R2 | −5.817 | d2 | 0.564 | | | | |
| R3 | 81.946 | d3 | 2.518 | nd3 | 1.5444 | vd3 | 55.82 |
| R4 | −2.799 | d4 | 0.214 | | | | |
| R5 | −5.284 | d5 | 0.781 | nd4 | 1.6153 | vd4 | 25.94 |
| R6 | 3.487 | d6 | 0.975 | | | | |
| R7 | 81.015 | d7 | 2.747 | nd5 | 1.6700 | vd5 | 19.39 |
| R8 | −20.898 | d8 | d8 | | | | |
| R9 | 22.158 | d9 | 8.217 | nd6 | 1.5346 | vd6 | 55.69 |
| R10 | 21.428 | d10 | 3.581 | | | | |
| R11 | ∞ | d11 | 0.210 | ndg | 1.5168 | vdg | 64.17 |
| R12 | ∞ | d12 | 1.356 | | | | |

In the Table 1, dp1=“dp1-01”+“dp1-02”, “dp1-01”=5.000, and “dp1-02”=4.800.

Table 2 lists data of relevant optical parameters of the camera optical lens 10 in the first embodiment of the present disclosure in the first state and the second state, respectively.

TABLE 2

| | First state | Second state |
|---|---|---|
| fA | 16.920 | 16.250 |
| FOV | 23.52° | 22.69° |
| FNO | 2.12 | 2.22 |
| d0 | 12.759 | 10.743 |
| dp2 | 3.237 | 1.221 |
| d8 | 0.400 | 2.416 |

The meanings of the symbols in the above table are listed as follows.
R: curvature radius of the optical surface, and central curvature radius in the case of a lens;
ST: aperture;
Rp1: curvature radius of the object-side surface of the first prism P1;
Rp2: curvature radius of the image-side surface of the first prism P1;
R1: curvature radius of the object-side surface of the first lens L1;
R2: curvature radius of the image-side surface of the first lens L1;
R3: curvature radius of the object-side surface of the second lens L2;
R4: curvature radius of the image-side surface of the second lens L2;
R5: curvature radius of the object-side surface of the third lens L3;
R6: curvature radius of the image-side surface of the third lens L3;
R7: curvature radius of the object-side surface of the fourth lens L4;
R8: curvature radius of the image-side surface of the fourth lens L4;
R9: curvature radius of the object-side surface of the fifth lens L5;
R10: curvature radius of the image-side surface of the fifth lens L5;
R11: curvature radius of the object-side surface of the sixth lens L6;
R12: curvature radius of the image-side surface of the sixth lens L6;
d: on-axis thickness of the lens or on-axis distance between adjacent lenses;
d0: on-axis distance from the aperture ST to the object-side surface of the first prism P1;
dp1: sum of an on-axis distance from the object-side surface of the first prism P1 to the reflective surface and an on-axis distance from the reflective surface to the image-side surface of the first prism P1;
dp1-01: on-axis distance from the object-side surface of the first prism P1 to the reflective surface;
dp1-02: on-axis distance from the reflective surface of the first prism P1 to the image-side surface;
dp2: on-axis distance from the image-side surface of the first prism P1 to the object-side surface of the first lens L1;
d1: on-axis thickness of the first lens L1;
d2: on-axis distance from the image-side surface of the first lens L1 to the object-side surface of the second lens L2;
d3: on-axis thickness of the second lens L2;
d4: on-axis distance from the image-side surface of the second lens L2 to the object-side surface of the third lens L3;
d5: on-axis thickness of the third lens L3;
d6: on-axis distance from the image-side surface of the third lens L3 to the object-side surface of the fourth lens L4;
d7: on-axis thickness of the fourth lens L4;
d8: on-axis distance from the image-side surface of the fourth lens L4 to the object-side surface of the fifth lens L5;
d9: on-axis thickness of the fifth lens L5;
d10: on-axis distance from the image-side surface of the fifth lens L5 to the object-side surface of the optical filter GF;
d11: on-axis thickness of the optical filter GF;
d12: on-axis distance from the image-side surface of the optical filter GF to the image surface Si;
nd: refractive index of d-line;
nd1: refractive index of the first prism P1;
nd2: refractive index of the first lens L1;
nd3: refractive index of the second lens L2;
nd4: refractive index of the third lens L3;
nd5: refractive index of the fourth lens L4;
nd6: refractive index of the fifth lens L5;
ndg: refractive index of the optical filter;
vd: Abbe number;
vd1: Abbe number of the first prism P1;
vd2: Abbe number of the first lens L1;
vd3: Abbe number of the second lens L2;
vd4: Abbe number of the third lens L3;
vd5: Abbe number of the fourth lens L4;
vd6: Abbe number of the fifth lens L5;
vdg: Abbe number of the optical filter.

Table 3 shows a conic coefficient k and aspheric coefficients of the camera optical lens Table 3

TABLE 3

| | Conic | | | | | |
|---|---|---|---|---|---|---|
| | coefficient | Aspheric coefficient | | | | |
| | k | A4 | A6 | A8 | A10 | A12 |
| R1 | 3.92935E+01 | −2.95830E−05 | 9.90840E−07 | −1.42110E−07 | 1.43940E−08 | −9.82560E−10 |
| R2 | 0.00000E+00 | 0.00000E+00 | 0.00000E+00 | 0.00000E+00 | 0.00000E+00 | 0.00000E+00 |
| R3 | 5.58177E+00 | 7.64710E−04 | 1.91490E−05 | −2.13410E−06 | 3.12520E−07 | 2.20740E−09 |
| R4 | −7.90869E+00 | 1.38190E−03 | −3.77070E−04 | 5.09880E−05 | −4.71240E−06 | 3.16750E−07 |
| R5 | 1.17438E+02 | 6.51310E−03 | −1.11420E−03 | 1.27670E−04 | −1.13620E−05 | 7.82840E−07 |
| R6 | −7.95447E+00 | 1.68360E−03 | −5.94080E−04 | 1.14260E−04 | −1.36660E−05 | 1.09400E−06 |
| R7 | −1.77715E+01 | −3.38770E−03 | 1.12440E−03 | −1.50110E−04 | 1.32880E−05 | −8.13290E−07 |
| R8 | −1.39677E+01 | −7.68300E−03 | 1.59170E−03 | −2.44420E−04 | 2.45130E−05 | −1.73300E−06 |
| R9 | 1.99000E+02 | −7.17060E−03 | 6.49230E−04 | −3.98000E−05 | 1.29300E−06 | −4.43660E−08 |
| R10 | 5.70542E+00 | 1.68290E−04 | 5.25910E−05 | 3.22190E−06 | −2.95960E−07 | 1.72890E−08 |
| R11 | 3.84196E+00 | −9.15750E−06 | 2.51630E−05 | −9.54120E−06 | 2.04270E−06 | −2.60230E−07 |
| R12 | −5.17153E+00 | 5.54010E−04 | 1.98630E−05 | −8.75110E−06 | 2.66760E−06 | −4.87170E−07 |

| | Conic coefficient | | | | | |
|---|---|---|---|---|---|---|
| | k | A14 | A16 | A18 | A20 | / |
| R1 | 3.92935E+01 | 4.37200E−11 | −1.21470E−12 | 1.90890E−14 | −1.29390E−16 | / |
| R2 | 0.00000E+00 | 0.00000E+00 | 0.00000E+00 | 0.00000E+00 | 0.00000E+00 | / |
| R3 | 5.58177E+00 | −3.59210E−09 | 3.88100E−10 | −1.82500E−11 | 3.49940E−13 | / |
| R4 | −7.90869E+00 | −1.51840E−08 | 4.84530E−10 | −9.09550E−12 | 7.53140E−14 | / |
| R5 | 1.17438E+02 | −3.81070E−08 | 1.19370E−09 | −2.13370E−11 | 1.64510E−13 | / |
| R6 | −7.95447E+00 | −5.67400E−08 | 1.80770E−09 | −3.20140E−11 | 2.40600E−13 | / |
| R7 | −1.77715E+01 | 3.44420E−08 | −9.97130E−10 | 1.80730E−11 | −1.52910E−13 | / |
| R8 | −1.39677E+01 | 8.52130E−08 | −2.71280E−09 | 4.94970E−11 | −3.88950E−13 | / |
| R9 | 1.99000E+02 | 5.27430E−09 | −3.46740E−10 | 9.85490E−12 | −1.02210E−13 | / |
| R10 | 5.70542E+00 | −1.97820E−09 | 1.96750E−10 | −9.38540E−12 | 1.63310E−13 | / |
| R11 | 3.84196E+00 | 2.01690E−08 | −9.35220E−10 | 2.39100E−11 | −2.59960E−13 | / |
| R12 | −5.17153E+00 | 5.50970E−08 | −3.75110E−09 | 1.40660E−10 | −2.22980E−12 | / |

It should be noted that an aspheric surface of each lens surface in this embodiment uses the aspheric surfaces shown in the above condition (25). However, the specific form of the condition (25) below is only an example, and the present disclosure is not limited to the aspherical polynomial form shown in the condition (25).

$$z = ( c {r}^{2} ) / {\{ 1 + [ 1 - ( k + 1 ) ( {c}^{2} {r}^{2} ) ] \}}^{1 / 2} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 25 )$$

K is a conic coefficient, and A4, A6, A8, A10, A12, A14, A16, A18, and A20 are aspheric surface coefficients. c is a curvature at the center of the optical surface, r is a vertical distance between the point on an aspheric curve and the optical axis, and z is an aspheric depth (a vertical distance between the point on the aspheric surface having a distance of r from the optical axis, and a tangent plane tangent to a vertex on the optical axis of an aspheric surface).

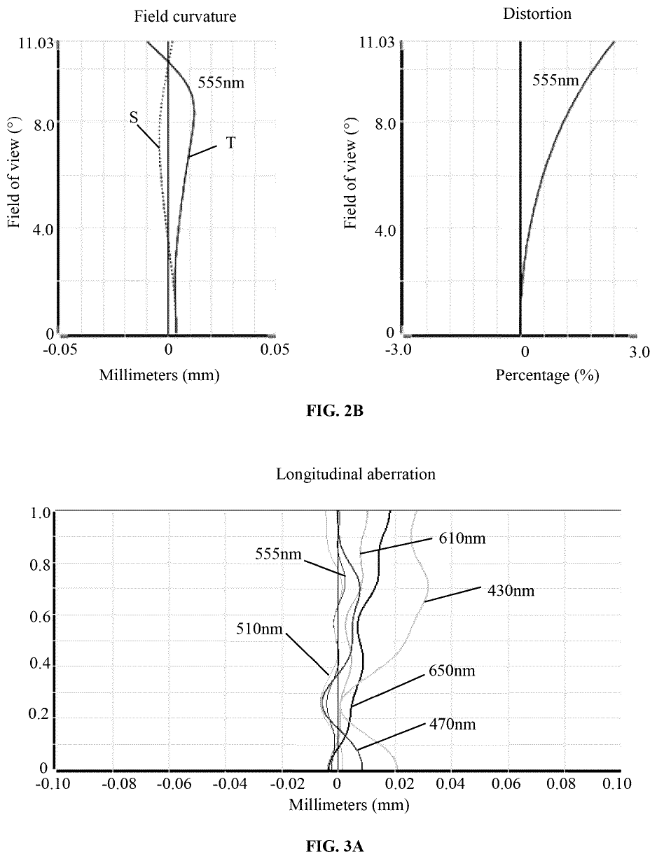

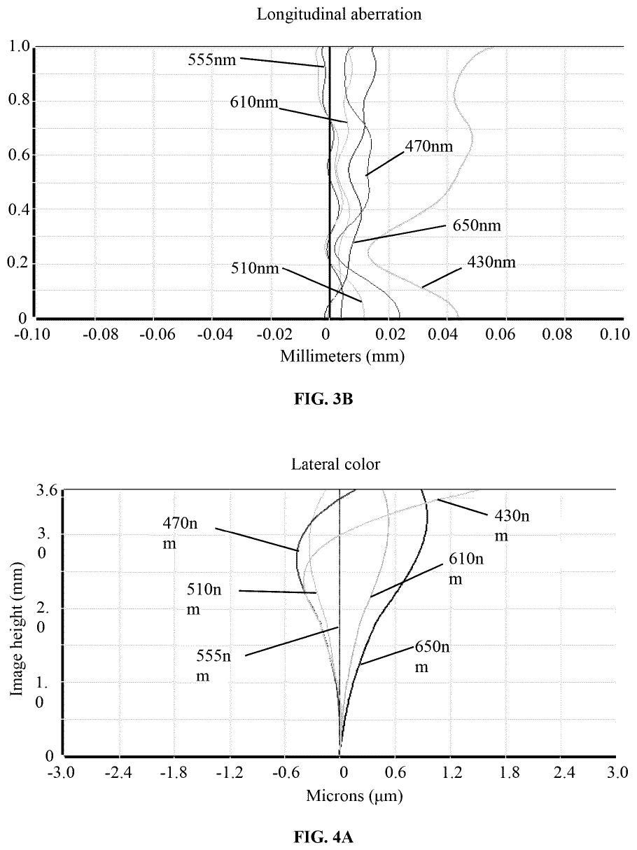

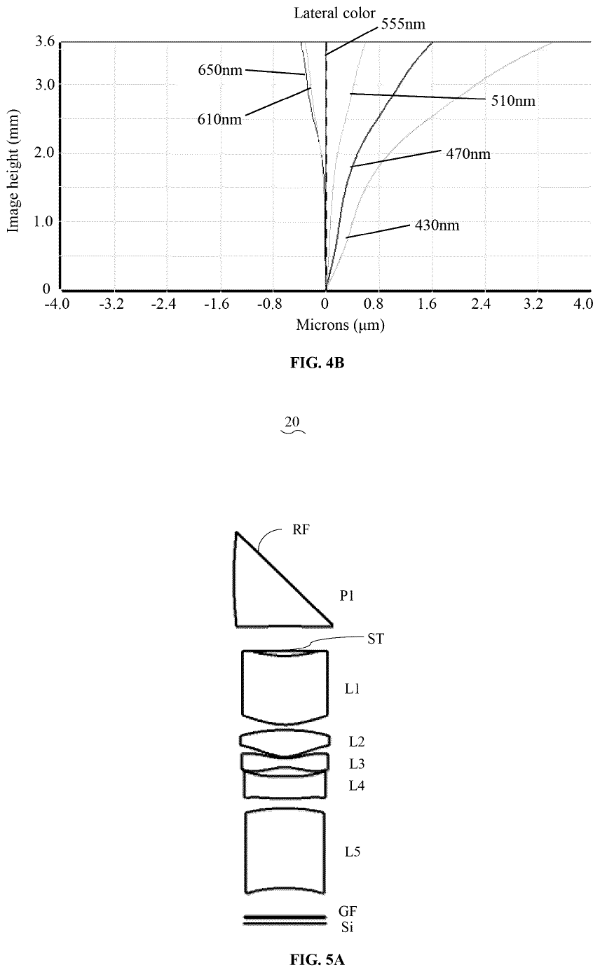

FIG. 2A and FIG. 2B show diagrams illustrating astigmatism field curvatures and distortions after light having a wavelength of 555 nm passes through the camera optical lens 10 of the first embodiment. FIG. 3A and FIG. 3B show diagrams illustrating longitudinal aberrations after light having wavelengths of 430 nm, 470 nm, 510 nm, 555 nm, 610 nm, and 650 nm passes through the camera optical lens 10 of the first embodiment. FIG. 4A and FIG. 4B show diagrams illustrating lateral colors after light having wavelengths of 430 nm, 470 nm, 510 nm, 555 nm, 610 nm, and 650 nm passes through the camera optical lens 10 of the first embodiment.

In this embodiment, for the camera optical lens 10 in the first state, the entrance pupil diameter (ENPD) is 8.000 mm, the full vision field image height IH is 3.600 mm, and the field of view (FOV) is 23.52°. The camera optical lens 10 can achieve a large-aperture periscope design with good optical performance. Axial and off-axis chromatic aberrations of the camera optical lens 10 are fully corrected, achieving excellent optical characteristics.

### Second Embodiment

The first prism P1 has a positive refractive power, the object-side surface of the first prism P1 is convex in a paraxial region, and the image-side surface of the first prism P1 is concave in the paraxial region.

The first lens L1 has a positive refractive power, the object-side surface of the first lens L1 is concave in a paraxial region, and the image-side surface of the first lens L1 is convex in the paraxial region.

The second lens L2 has a positive refractive power, the object-side surface of the second lens L2 is convex in a paraxial region, and the image-side surface of the second lens L2 is convex in the paraxial region.

The third lens L3 has a negative refractive power, the object-side surface of the third lens L3 is concave in a paraxial region; the image-side surface of the third lens L3 is concave in the paraxial region.

The fourth lens L4 has a positive refractive power, the object-side surface of the fourth lens L4 is convex in a paraxial region; the image-side surface of the fourth lens L4 is convex in the paraxial region.

The fifth lens L5 has a positive refractive power, the object-side surface of the fifth lens L5 is convex in a paraxial region; the image-side surface of the fifth lens L5 is concave in the paraxial region.

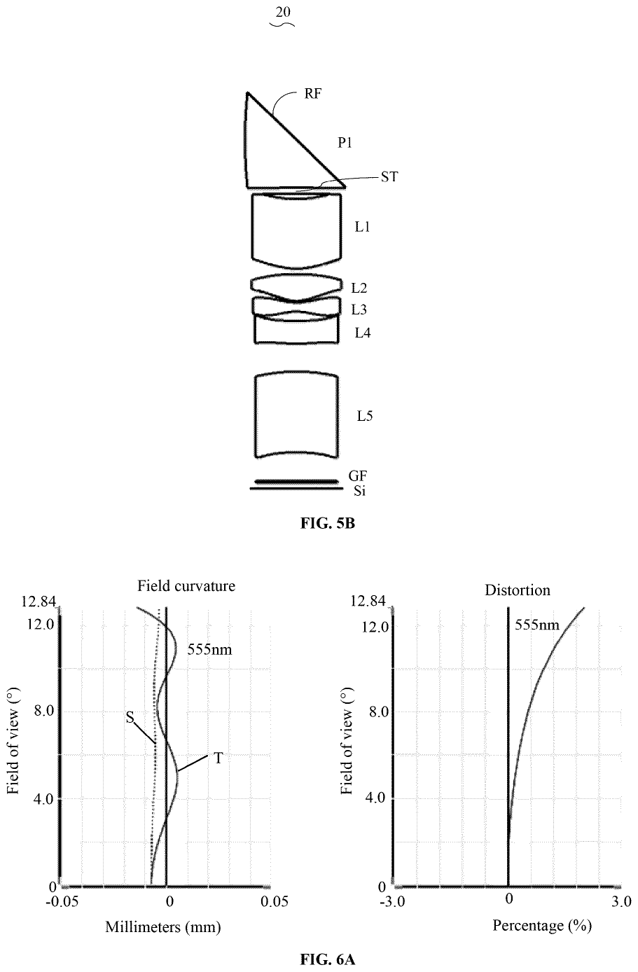

FIG. 5A and FIG. 5B are schematic structural diagrams of the camera optical lens 20 in the second embodiment, and the meanings of the symbols in the second embodiment are the same as the meanings of the symbols in the first embodiment.

Table 4 shows design data of the camera optical lens 20 in the second embodiment.

TABLE 4

| | R | d | | nd | | vd | |
|---|---|---|---|---|---|---|---|
| ST | ∞ | d0 | −12.302 | / | / | / | / |
| Rp1 | 45.862 | dp1 | 9.800 | nd1 | 1.8052 | vd1 | 40.89 |
| Rp2 | 130.416 | dp2 | 3.002 | | | | |
| R1 | −10.640 | d1 | 6.994 | nd2 | 1.6400 | vd2 | 23.54 |
| R2 | −5.874 | d2 | 0.552 | | | | |
| R3 | 54.045 | d3 | 2.701 | nd3 | 1.5444 | vd3 | 55.82 |
| R4 | −2.648 | d4 | 0.141 | | | | |
| R5 | −5.150 | d5 | 0.904 | nd4 | 1.6153 | vd4 | 25.94 |
| R6 | 3.314 | d6 | 0.915 | | | | |
| R7 | 68.673 | d7 | 2.295 | nd5 | 1.6700 | vd5 | 19.39 |
| R8 | −21.961 | d8 | 0.971 | | | | |
| R9 | 17.209 | d9 | 8.100 | nd6 | 1.5346 | vd6 | 55.69 |
| R10 | 17.016 | d10 | 2.817 | | | | |
| R11 | ∞ | d11 | 0.210 | ndg | 1.5168 | vdg | 64.17 |
| R12 | ∞ | d12 | 0.599 | | | | |

In the Table 5, dp1=“dp1-01”+“dp1-02”, “dp1-01”=5.000, and “dp1-02”=4.800.

Table 5 lists data of relevant optical parameters of the camera optical lens 20 in the second embodiment of the present disclosure in the first state and the second state, respectively.

TABLE 5

| | First state | Second state |
|---|---|---|
| fA | 15.480 | 15.860 |
| FOV | 25.67° | 24.68° |
| FNO | 2.12 | 2.26 |
| d0 | 12.302 | 10.404 |
| dp2 | 3.002 | 1.104 |
| d8 | 0.971 | 2.869 |

Table 6 shows a conic coefficient k and aspheric coefficients of the camera optical lens 20.

TABLE 6

| | Conic coefficient | Aspheric coefficients | | | | |
|---|---|---|---|---|---|---|
| | k | A4 | A6 | A8 | A10 | A12 |
| R1 | 2.33370E+01 | −4.31030E−05 | 7.07450E−07 | −1.32990E−07 | 1.40340E−08 | −9.81570E−10 |
| R2 | 0.00000E+00 | 0.00000E+00 | 0.00000E+00 | 0.00000E+00 | 0.00000E+00 | 0.00000E+00 |
| R3 | 5.40731E+00 | 7.83940E−04 | 2.69380E−05 | −2.20130E−06 | 3.32220E−07 | 3.45150E−09 |
| R4 | −8.23642E+00 | 1.32920E−03 | −3.72230E−04 | 5.10130E−05 | −4.71790E−06 | 3.16580E−07 |
| R5 | 1.00559E+02 | 6.58450E−03 | −1.11670E−03 | 1.27550E−04 | −1.13650E−05 | 7.82840E−07 |
| R6 | −7.55322E+00 | 1.70400E−03 | −5.94560E−04 | 1.14280E−04 | −1.36630E−05 | 1.09400E−06 |
| R7 | −1.68669E+01 | −3.45860E−03 | 1.13440E−03 | −1.49800E−04 | 1.32880E−05 | −8.13400E−07 |
| R8 | −1.30561E+01 | −7.56320E−03 | 1.58880E−03 | −2.44570E−04 | 2.45130E−05 | −1.73290E−06 |
| R9 | 1.83259E+02 | −7.15990E−03 | 6.52110E−04 | −3.98780E−05 | 1.28050E−06 | −4.48340E−08 |
| R10 | 1.26163E+00 | 2.18400E−04 | 6.12650E−05 | 3.50760E−06 | −3.00760E−07 | 1.70710E−08 |
| R11 | 2.65219E+00 | −5.02390E−05 | 2.72670E−05 | −9.81170E−06 | 2.05220E−06 | −2.59770E−07 |
| R12 | −3.33012E+00 | 6.46990E−04 | 1.26090E−05 | −5.19270E−06 | 2.27630E−06 | −4.68200E−07 |
| | Conic coefficient | | | | | |
| | k | A14 | A16 | A18 | A20 | / |
| R1 | 2.33370E+01 | 4.39180E−11 | −1.21310E−12 | 1.88570E−14 | −1.26740E−16 | / |
| R2 | 0.00000E+00 | 0.00000E+00 | 0.00000E+00 | 0.00000E+00 | 0.00000E+00 | / |
| R3 | 5.40731E+00 | −3.60720E−09 | 3.82900E−10 | −1.84040E−11 | 3.96380E−13 | / |
| R4 | −8.23642E+00 | −1.51820E−08 | 4.84780E−10 | −9.09280E−12 | 7.51240E−14 | / |
| R5 | 1.00559E+02 | −3.81030E−08 | 1.19390E−09 | −2.13370E−11 | 1.63970E−13 | / |
| R6 | −7.55322E+00 | −5.67420E−08 | 1.80750E−09 | −3.20190E−11 | 2.40720E−13 | / |
| R7 | −1.68669E+01 | 3.44400E−08 | −9.97060E−10 | 1.80770E−11 | −1.53080E−13 | / |
| R8 | −1.30561E+01 | 8.52120E−08 | −2.71300E−09 | 4.95010E−11 | −3.88130E−13 | / |
| R9 | 1.83259E+02 | 5.26960E−09 | −3.46590E−10 | 9.87090E−12 | −1.01820E−13 | / |
| R10 | 1.26163E+00 | −1.98100E−09 | 1.96390E−10 | −9.45050E−12 | 1.65740E−13 | / |
| R11 | 2.65219E+00 | 2.01460E−08 | −9.36070E−10 | 2.39420E−11 | −2.59460E−13 | / |
| R12 | −3.33012E+00 | 5.50450E−08 | −3.74500E−09 | 1.37560E−10 | −2.11250E−12 | / |

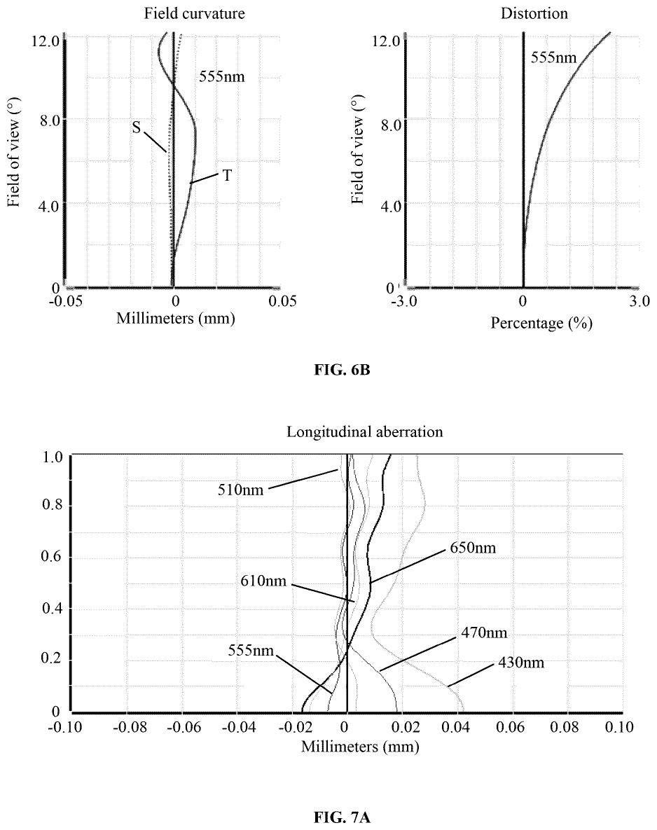

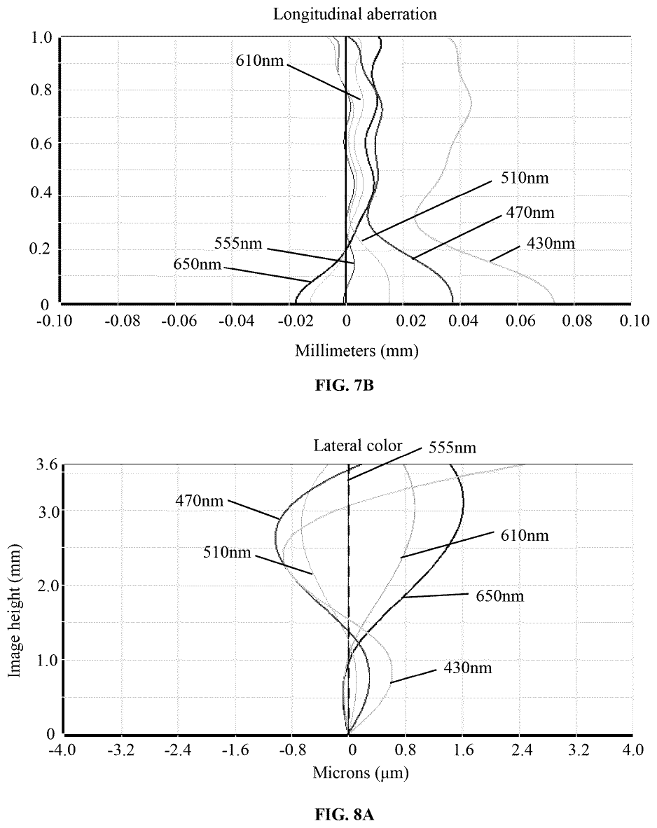

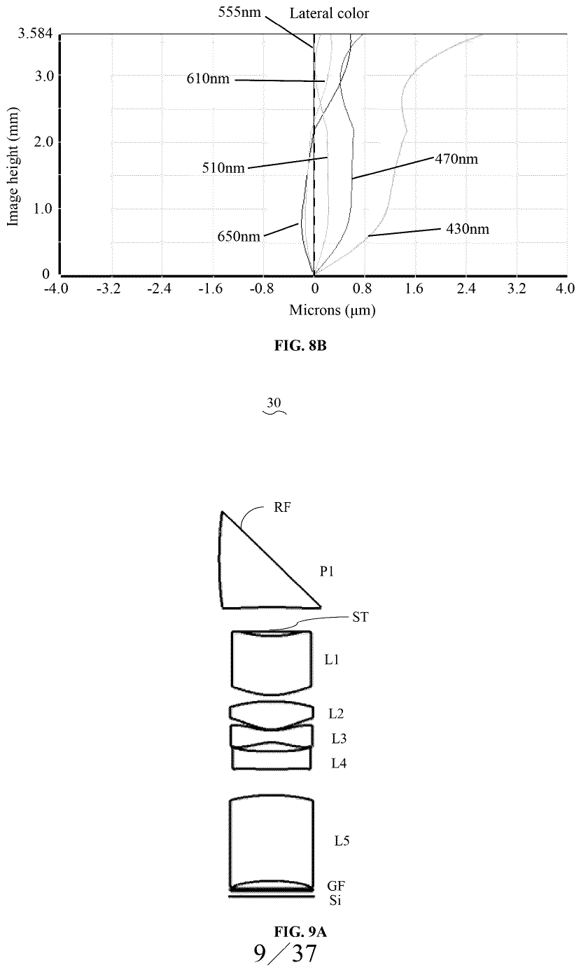

FIG. 6A and FIG. 6B show diagrams illustrating astigmatism field curvatures and distortions after light having a wavelength of 555 nm passes through the camera optical lens 20 of the second embodiment. FIG. 7A and FIG. 7B show diagrams illustrating longitudinal aberrations after light having wavelengths of 430 nm, 470 nm, 510 nm, 555 nm, 610 nm, and 650 nm passes through the camera optical lens 20 of the second embodiment. FIG. 8A and FIG. 8B show diagrams illustrating lateral colors after light having wavelengths of 430 nm, 470 nm, 510 nm, 555 nm, 610 nm, and 650 nm passes through the camera optical lens 20 of the second embodiment.

In this embodiment, for the camera optical lens 20 in the first state, the entrance pupil diameter (ENPD) is 7.319 mm, the full vision field image height IH is 3.600 mm, and the field of view (FOV) is 25.67°. The camera optical lens 20 can achieve a large-aperture periscope design with good optical performance. Axial and off-axis chromatic aberrations of the camera optical lens 20 are fully corrected, achieving excellent optical characteristics.

### Third Embodiment

The first prism P1 has a positive refractive power, the object-side surface of the first prism P1 is convex in a paraxial region, and the image-side surface of the first prism P1 is concave in the paraxial region.

The first lens L1 has a positive refractive power, the object-side surface of the first lens L1 is concave in a paraxial region, and the image-side surface of the first lens L1 is convex in the paraxial region.

The second lens L2 has a positive refractive power, the object-side surface of the second lens L2 is convex in a paraxial region, and the image-side surface of the second lens L2 is convex in the paraxial region.

The third lens L3 has a negative refractive power, the object-side surface of the third lens L3 is concave in a paraxial region; the image-side surface of the third lens L3 is concave in the paraxial region.

The fourth lens L4 has a positive refractive power, the object-side surface of the fourth lens L4 is convex in a paraxial region; the image-side surface of the fourth lens L4 is convex in the paraxial region.

The fifth lens L5 has a positive refractive power, the object-side surface of the fifth lens L5 is convex in a paraxial region; the image-side surface of the fifth lens L5 is concave in the paraxial region.

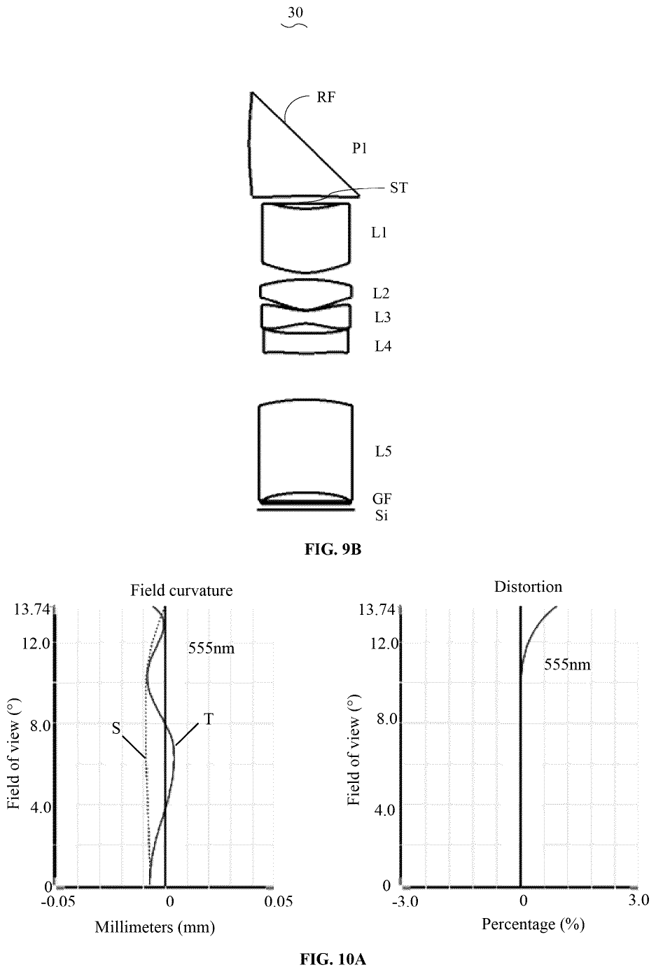

FIG. 9A and FIG. 9B are schematic structural diagrams of the camera optical lens 30 in the third embodiment, and the meanings of the symbols in the third embodiment are the same as the meanings of the symbols in the first embodiment.

Table 7 shows design data of the camera optical lens 30 in the third embodiment.

TABLE 7

| | R | d | | nd | | vd | |
|---|---|---|---|---|---|---|---|
| ST | ∞ | d0 | −12.235 | / | / | / | / |
| Rp1 | 39.025 | dp1 | 9.800 | nd1 | 1.8052 | vd1 | 40.89 |
| Rp2 | 58.247 | dp2 | 2.878 | | | | |
| R1 | −10.004 | d1 | 5.860 | nd2 | 1.6400 | vd2 | 23.54 |
| R2 | −5.689 | d2 | 0.622 | | | | |
| R3 | 34.160 | d3 | 2.785 | nd3 | 1.5444 | vd3 | 55.82 |
| R4 | −2.653 | d4 | 0.057 | | | | |
| R5 | −5.294 | d5 | 1.181 | nd4 | 1.6153 | vd4 | 25.94 |
| R6 | 3.227 | d6 | 0.871 | | | | |
| R7 | 48.003 | d7 | 1.838 | nd5 | 1.6700 | vd5 | 19.39 |
| R8 | −23.172 | d8 | 2.528 | | | | |
| R9 | 15.683 | d9 | 8.500 | nd6 | 1.5346 | vd6 | 55.69 |
| R10 | 16.684 | d10 | 0.790 | | | | |
| R11 | ∞ | d11 | 0.210 | ndg | 1.5168 | vdg | 64.17 |
| R12 | ∞ | d12 | 0.586 | | | | |

In the Table 7, dp1=“dp1-01”+“dp1-02”, “dp1-01”=5.000, and “dp1-02”=4.800.

Table 8 lists data of relevant optical parameters of the camera optical lens 30 in the third embodiment of the present disclosure in the first state and the second state, respectively.

TABLE 8

| | First state | Second state |
|---|---|---|
| fA | 14.580 | 13.680 |
| FOV | 27.48° | 26.58° |
| FNO | 2.12 | 2.14 |
| d0 | 12.235 | 10.237 |
| dp2 | 2.878 | 0.880 |
| d8 | 2.528 | 4.526 |

Table 9 shows a conic coefficient k and aspheric coefficients of the camera optical lens 30.

TABLE 9

| | Conic coefficient | Aspheric coefficient | | | | |
|---|---|---|---|---|---|---|
| | k | A4 | A6 | A8 | A10 | A12 |
| R1 | 1.30348E+01 | −3.62330E−05 | 3.90860E−07 | −1.00460E−07 | 1.22590E−08 | −9.32640E−10 |
| R2 | 0.00000E+00 | 0.00000E+00 | 0.00000E+00 | 0.00000E+00 | 0.00000E+00 | 0.00000E+00 |
| R3 | 5.18981E+00 | 8.39770E−04 | 4.41860E−05 | −4.15300E−06 | 5.24580E−07 | 9.94060E−09 |
| R4 | −7.22541E+00 | 1.19820E−03 | −3.65560E−04 | 5.12380E−05 | −4.72950E−06 | 3.15650E−07 |
| R5 | 4.41343E+01 | 6.49790E−03 | −1.11610E−03 | 1.27370E−04 | −1.13720E−05 | 7.82940E−07 |
| R6 | −7.03339E+00 | 1.54040E−03 | −5.93080E−04 | 1.14420E−04 | −1.36570E−05 | 1.09390E−06 |
| R7 | −1.56811E+01 | −3.78850E−03 | 1.14890E−03 | −1.49370E−04 | 1.32820E−05 | −8.14180E−07 |
| R8 | −1.13513E+01 | −7.21640E−03 | 1.57510E−03 | −2.45310E−04 | 2.45100E−05 | −1.73230E−06 |
| R9 | 1.00265E+02 | −7.16660E−03 | 6.63730E−04 | −3.98180E−05 | 1.25440E−06 | −4.61580E−08 |
| R10 | 1.13786E+00 | 1.81840E−04 | 7.28920E−05 | 4.86200E−06 | −2.85830E−07 | 1.52870E−08 |
| R11 | 2.32665E+00 | −9.70380E−05 | 2.42450E−05 | −9.69580E−06 | 2.06350E−06 | −2.60140E−07 |
| R12 | 1.61375E+01 | 3.33590E−04 | −4.42040E−05 | −2.24210E−06 | 2.07740E−06 | −4.23490E−07 |
| | Conic coefficient | | | | | |
| | k | A14 | A16 | A18 | A20 | / |
| R1 | 1.30348E+01 | 4.38840E−11 | −1.24370E−12 | 1.94210E−14 | −1.28430E−16 | / |
| R2 | 0.00000E+00 | 0.00000E+00 | 0.00000E+00 | 0.00000E+00 | 0.00000E+00 | / |
| R3 | 5.18981E+00 | −5.35780E−09 | 4.53740E−10 | −1.73090E−11 | 3.83520E−13 | / |
| R4 | −7.22541E+00 | −1.51870E−08 | 4.86810E−10 | −8.99850E−12 | 7.01540E−14 | / |
| R5 | 4.41343E+01 | −3.80880E−08 | 1.19430E−09 | −2.13420E−11 | 1.62720E−13 | / |
| R6 | −7.03339E+00 | −5.67510E−08 | 1.80720E−09 | −3.20200E−11 | 2.41510E−13 | / |
| R7 | −1.56811E+01 | 3.44210E−08 | −9.97310E−10 | 1.81030E−11 | −1.52080E−13 | / |
| R8 | −1.13513E+01 | 8.52300E−08 | −2.71310E−09 | 4.94920E−11 | −3.85960E−13 | / |
| R9 | 1.00265E+02 | 5.25450E−09 | −3.45280E−10 | 9.96720E−12 | −1.01360E−13 | / |
| R10 | 1.13786E+00 | −2.05010E−09 | 1.96110E−10 | −9.47750E−12 | 1.72180E−13 | / |
| R11 | 2.32665E+00 | 2.01180E−08 | −9.36640E−10 | 2.40860E−11 | −2.62560E−13 | / |
| R12 | 1.61375E+01 | 5.00630E−08 | −3.52570E−09 | 1.37630E−10 | −2.31400E−12 | / |

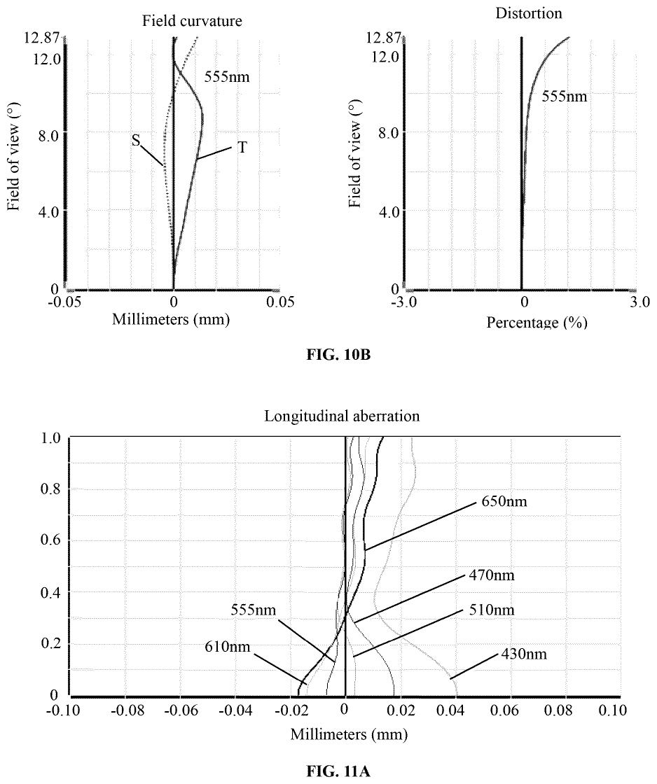

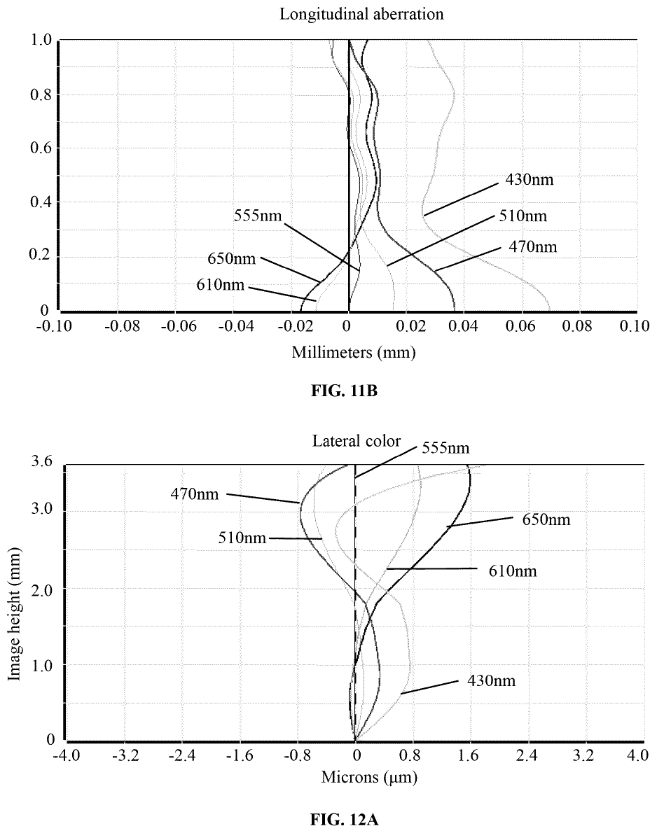

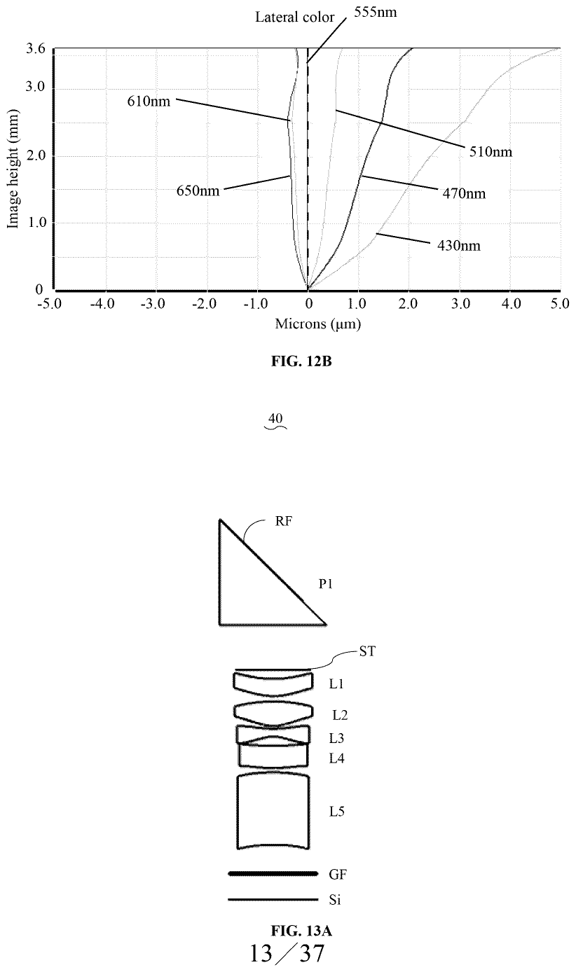

FIG. 10A and FIG. 10B show diagrams illustrating astigmatism field curvatures and distortions after light having a wavelength of 555 nm passes through the camera optical lens 30 of the third embodiment. FIG. 11A and FIG. 11B show diagrams illustrating longitudinal aberrations after light having wavelengths of 430 nm, 470 nm, 510 nm, 555 nm, 610 nm, and 650 nm passes through the camera optical lens 30 of the third embodiment. FIG. 12A and FIG. 12B show diagrams illustrating lateral colors after light having wavelengths of 430 nm, 470 nm, 510 nm, 555 nm, 610 nm, and 650 nm passes through the camera optical lens 30 of the third embodiment.

In this embodiment, for the camera optical lens 30 in the first state, the entrance pupil diameter (ENPD) is 6.894 mm, the full vision field image height IH is 3.600 mm, and the field of view (FOV) is 27.48°. The camera optical lens 30 can achieve a large-aperture periscope design with good optical performance. Axial and off-axis chromatic aberrations of the camera optical lens 30 are fully corrected, achieving excellent optical characteristics.

### Fourth Embodiment

The first prism P1 has a positive refractive power, the object-side surface of the first prism P1 is flat in a paraxial region, and the image-side surface of the first prism P1 is flat in the paraxial region.

The first lens L1 has a positive refractive power, the object-side surface of the first lens L1 is concave in a paraxial region, and the image-side surface of the first lens L1 is convex in the paraxial region.

The second lens L2 has a positive refractive power, the object-side surface of the second lens L2 is convex in a paraxial region, and the image-side surface of the second lens L2 is convex in the paraxial region.

The third lens L3 has a negative refractive power, the object-side surface of the third lens L3 is concave in a paraxial region; the image-side surface of the third lens L3 is concave in the paraxial region.

The fourth lens L4 has a positive refractive power, the object-side surface of the fourth lens L4 is convex in a paraxial region; the image-side surface of the fourth lens L4 is convex in the paraxial region.

The fifth lens L5 has a positive refractive power, the object-side surface of the fifth lens L5 is convex in a paraxial region; the image-side surface of the fifth lens L5 is concave in the paraxial region.

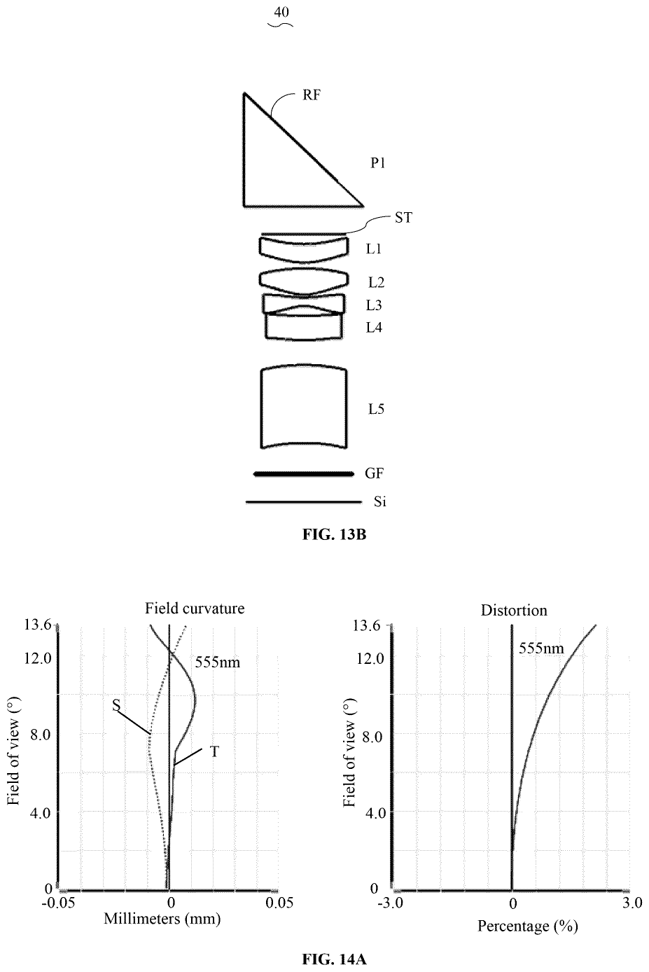

FIG. 13A and FIG. 13B are schematic structural diagrams of the camera optical lens 40 in the fourth embodiment, and the meanings of the symbols in the fourth embodiment are the same as the meanings of the symbols in the first embodiment.

Table 10 shows design data of the camera optical lens 40 in the fourth embodiment.

TABLE 10

| | R | d | | nd | | vd | |
|---|---|---|---|---|---|---|---|
| ST | ∞ | d0 | −13.915 | / | / | / | / |
| Rp1 | 400.000 | dp1 | 9.800 | nd1 | 1.8052 | vd1 | 40.89 |
| Rp2 | 547.945 | dp2 | 4.957 | | | | |
| R1 | −9.042 | d1 | 1.610 | nd2 | 1.6400 | vd2 | 23.54 |
| R2 | −5.278 | d2 | 0.508 | | | | |
| R3 | 25.121 | d3 | 2.253 | nd3 | 1.5444 | vd3 | 55.82 |
| R4 | −2.791 | d4 | 0.247 | | | | |
| R5 | −8.957 | d5 | 0.718 | nd4 | 1.6153 | vd4 | 25.94 |
| R6 | 2.494 | d6 | 0.813 | | | | |
| R7 | 59.300 | d7 | 2.109 | nd5 | 1.6700 | vd5 | 19.39 |
| R8 | −14.777 | d8 | 0.400 | | | | |
| R9 | 14.565 | d9 | 6.708 | nd6 | 1.5346 | vd6 | 55.69 |
| R10 | 16.200 | d10 | 2.543 | | | | |
| R11 | ∞ | d11 | 0.210 | ndg | 1.5168 | vdg | 64.17 |
| R12 | ∞ | d12 | 2.340 | | | | |

In the Table 10, dp1=“dp1-01”+“dp1-02”, “dp1-01”=5.000, and “dp1-02”=4.800.

Table 11 lists data of relevant optical parameters of the camera optical lens 40 in the fourth embodiment of the present disclosure in the first state and the second state, respectively.

TABLE 11

| | First state | Second state |
|---|---|---|
| fA | 14.580 | 13.850 |
| FOV | 27.18° | 26.05° |
| FNO | 2.12 | 2.15 |
| d0 | 13.915 | 11.879 |
| dp2 | 4.957 | 2.921 |
| d8 | 0.400 | 2.436 |

Table 12 shows a conic coefficient k and aspheric coefficients of the camera optical lens 40.

TABLE 12

| | Conic coefficient | Aspheric coefficient | | | | |
|---|---|---|---|---|---|---|
| | k | A4 | A6 | A8 | A10 | A12 |
| R1 | −5.70555E+03 | −2.20850E−05 | 5.91200E−07 | −1.15120E−07 | 1.28510E−08 | −9.31250E−10 |
| R2 | 0.00000E+00 | 0.00000E+00 | 0.00000E+00 | 0.00000E+00 | 0.00000E+00 | 0.00000E+00 |
| R3 | 3.70244E+00 | 1.68050E−03 | 5.37840E−05 | −5.83600E−06 | 4.99740E−07 | 1.34320E−08 |
| R4 | −7.07777E+00 | 1.52760E−03 | −3.47040E−04 | 5.02810E−05 | −4.76830E−06 | 3.17570E−07 |
| R5 | 2.57467E+01 | 6.02170E−03 | −1.12070E−03 | 1.28730E−04 | −1.13410E−05 | 7.81870E−07 |
| R6 | −8.75686E+00 | 1.58720E−03 | −5.90480E−04 | 1.15090E−04 | −1.36160E−05 | 1.09400E−06 |
| R7 | −4.01406E+01 | −3.40800E−03 | 1.15350E−03 | −1.50460E−04 | 1.32390E−05 | −8.16010E−07 |
| R8 | −8.17150E+00 | −7.02800E−03 | 1.55680E−03 | −2.45100E−04 | 2.44960E−05 | −1.73450E−06 |
| R9 | 1.78969E+02 | −6.61510E−03 | 6.87820E−04 | −3.94820E−05 | 1.26140E−06 | −4.68290E−08 |
| R10 | 2.02743E−01 | 5.99150E−04 | 7.99700E−05 | 5.60760E−06 | −2.40220E−07 | 1.61800E−08 |
| R11 | 1.66721E+00 | −1.25160E−05 | 2.38670E−05 | −9.31170E−06 | 2.03770E−06 | −2.63810E−07 |
| R12 | 1.43439E+01 | 2.17200E−04 | 3.62610E−07 | −6.95420E−06 | 2.22630E−06 | −4.30820E−07 |
| | Conic coefficient | | | | | |
| | k | A14 | A16 | A18 | A20 | / |
| R1 | −5.70555E+03 | 4.33060E−11 | −1.23760E−12 | 1.96630E−14 | −1.32400E−16 | / |
| R2 | 0.00000E+00 | 0.00000E+00 | 0.00000E+00 | 0.00000E+00 | 0.00000E+00 | / |
| R3 | 3.70244E+00 | −4.89010E−09 | 4.30260E−10 | −1.84530E−11 | 3.83520E−13 | / |
| R4 | −7.07777E+00 | −1.50350E−08 | 4.86410E−10 | −9.34000E−12 | 7.23400E−14 | / |
| R5 | 2.57467E+01 | −3.81470E−08 | 1.19310E−09 | −2.13550E−11 | 1.60060E−13 | / |
| R6 | −8.75686E+00 | −5.68590E−08 | 1.80080E−09 | −3.22540E−11 | 2.60140E−13 | / |
| R7 | −4.01406E+01 | 3.43720E−08 | −9.99580E−10 | 1.80170E−11 | −1.31980E−13 | / |
| R8 | −8.17150E+00 | 8.51450E−08 | −2.71320E−09 | 4.96220E−11 | −3.77290E−13 | / |
| R9 | 1.78969E+02 | 5.12920E−09 | −3.54030E−10 | 9.87150E−12 | −7.83420E−14 | / |
| R10 | 2.02743E−01 | −2.16980E−09 | 2.02760E−10 | −8.03830E−12 | 4.16610E−14 | / |
| R11 | 1.66721E+00 | 2.03780E−08 | −9.13920E−10 | 2.15580E−11 | −1.97890E−13 | / |
| R12 | 1.43439E+01 | 5.00630E−08 | −3.52570E−09 | 1.37630E−10 | −2.31400E−12 | / |

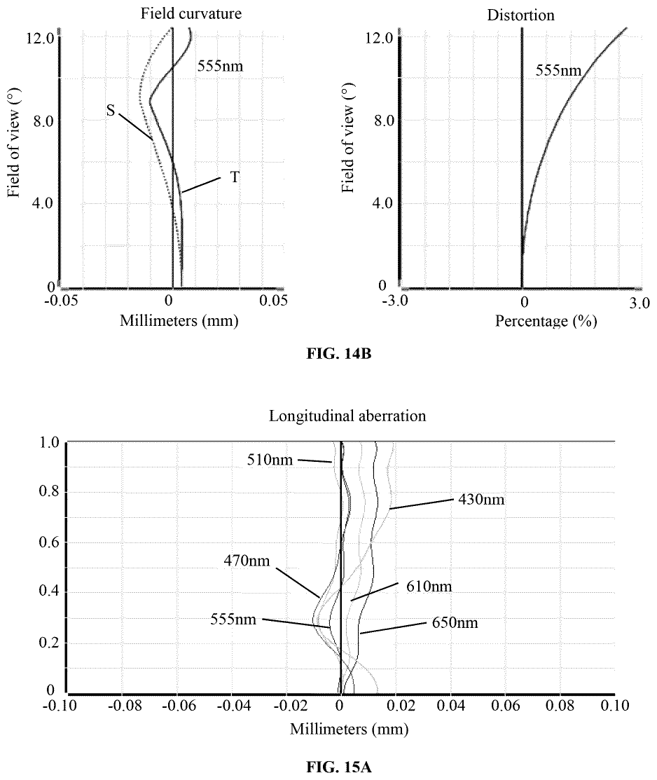

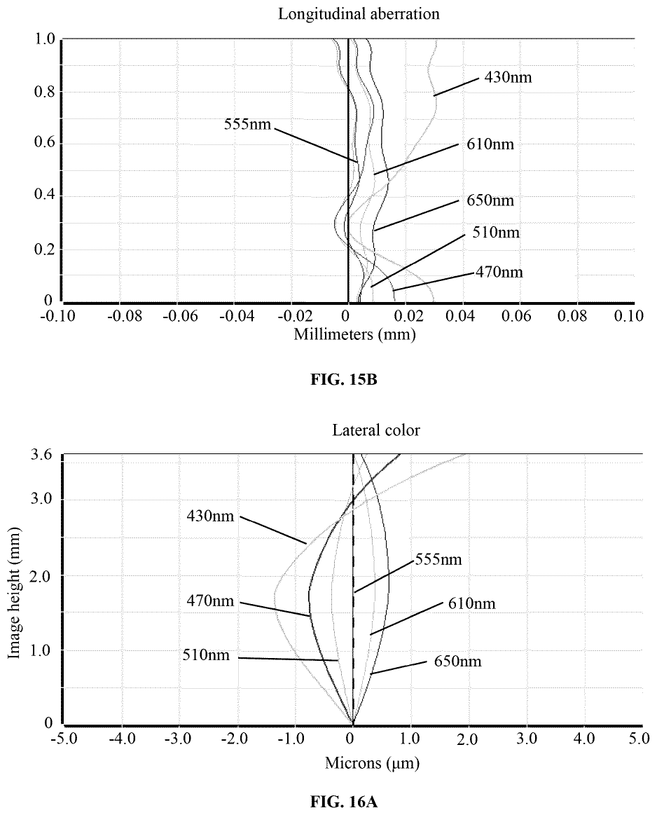

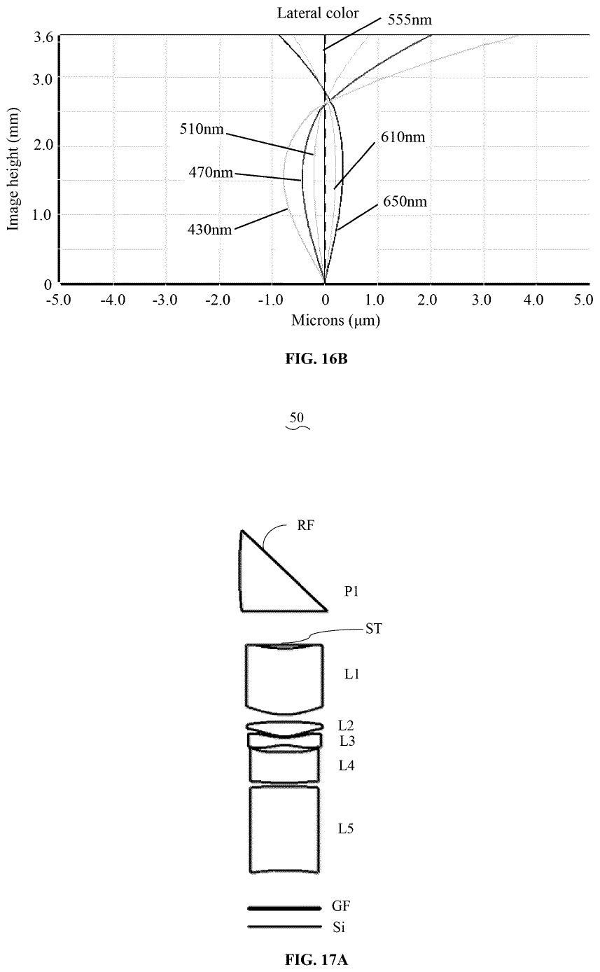

FIG. 14A and FIG. 14B show diagrams illustrating astigmatism field curvatures and distortions after light having a wavelength of 555 nm passes through the camera optical lens 40 of the fourth embodiment. FIG. 15A and FIG. 15B show diagrams illustrating longitudinal aberrations after light having wavelengths of 430 nm, 470 nm, 510 nm, 555 nm, 610 nm, and 650 nm passes through the camera optical lens 40 of the fourth embodiment. FIG. 16A and FIG. 16B show diagrams illustrating lateral colors after light having wavelengths of 430 nm, 470 nm, 510 nm, 555 nm, 610 nm, and 650 nm passes through the camera optical lens 40 of the fourth embodiment.

In this embodiment, for the camera optical lens 40 in the first state, the entrance pupil diameter (ENPD) is 6.894 mm, the full vision field image height IH is 3.600 mm, and the field of view (FOV) is 27.18°. The camera optical lens 40 can achieve a large-aperture periscope design with good optical performance. Axial and off-axis chromatic aberrations of the camera optical lens 40 are fully corrected, achieving excellent optical characteristics.

### Fifth Embodiment

The first prism P1 has a positive refractive power, the object-side surface of the first prism P1 is convex in a paraxial region, and the image-side surface of the first prism P1 is flat in the paraxial region.

The first lens L1 has a positive refractive power, the object-side surface of the first lens L1 is concave in a paraxial region, and the image-side surface of the first lens L1 is convex in the paraxial region.

The second lens L2 has a positive refractive power, the object-side surface of the second lens L2 is convex in a paraxial region, and the image-side surface of the second lens L2 is convex in the paraxial region.

The third lens L3 has a negative refractive power, the object-side surface of the third lens L3 is concave in a paraxial region; the image-side surface of the third lens L3 is concave in the paraxial region.

The fourth lens L4 has a positive refractive power, the object-side surface of the fourth lens L4 is convex in a paraxial region; the image-side surface of the fourth lens L4 is convex in the paraxial region.

The fifth lens L5 has a negative refractive power, the object-side surface of the fifth lens L5 is convex in a paraxial region; the image-side surface of the fifth lens L5 is concave in the paraxial region.

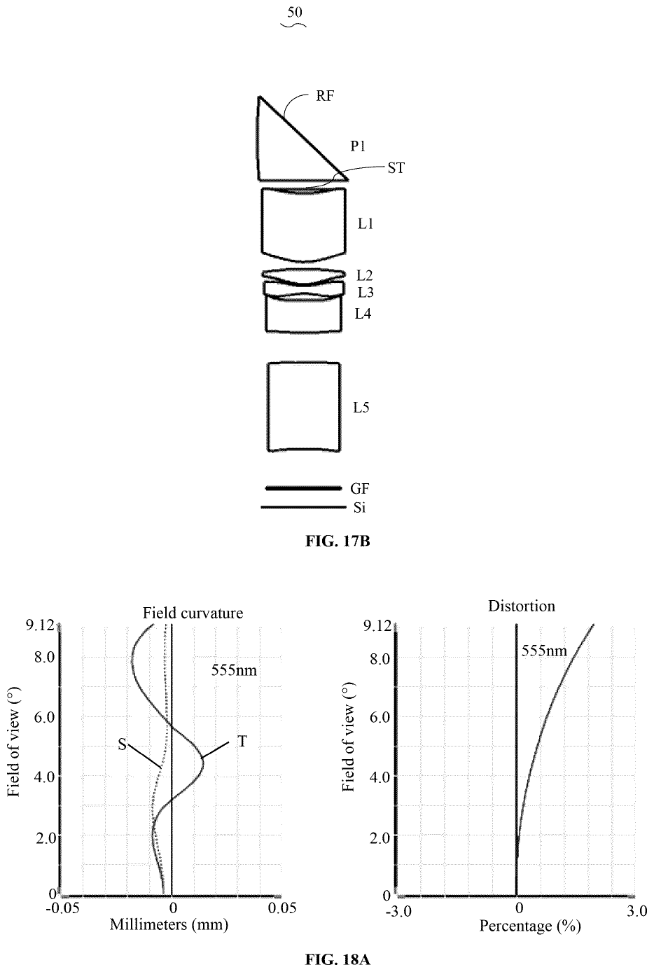

FIG. 17A and FIG. 17B are schematic structural diagrams of the camera optical lens 50 in the fifth embodiment, and the meanings of the symbols in the fifth embodiment are the same as the meanings of the symbols in the first embodiment.

Table 13 shows design data of the camera optical lens 50 in the fifth embodiment.

TABLE 13

| | R | d | | nd | | vd | |
|---|---|---|---|---|---|---|---|
| ST | ∞ | d0 | −13.675 | / | | / | / |
| Rp1 | 46.699 | dp1 | 9.800 | nd1 | 1.8052 | vd1 | 40.89 |
| Rp2 | −1556.642 | dp2 | 4.340 | | | | |
| R1 | −11.596 | d1 | 7.750 | nd2 | 1.6400 | vd2 | 23.54 |
| R2 | −5.922 | d2 | 0.815 | | | | |
| R3 | 143.895 | d3 | 1.731 | nd3 | 1.5444 | vd3 | 55.82 |
| R4 | −3.188 | d4 | 0.119 | | | | |
| R5 | −6.044 | d5 | 0.872 | nd4 | 1.6153 | vd4 | 25.94 |
| R6 | 3.691 | d6 | 0.825 | | | | |
| R7 | 68.219 | d7 | 3.624 | nd5 | 1.6700 | vd5 | 19.39 |
| R8 | −23.727 | d8 | 0.400 | | | | |
| R9 | 52.485 | d9 | 9.830 | nd6 | 1.5346 | vd6 | 55.69 |
| R10 | 31.178 | d10 | 4.308 | | | | |
| R11 | ∞ | d11 | 0.210 | ndg | 1.5168 | vdg | 64.17 |
| R12 | ∞ | d12 | 2.083 | | | | |

In the Table 13, dp1=“dp1-01”+“dp1-02”, “dp1-01”=5.000, and “dp1-02”=4.800.

Table 14 lists data of relevant optical parameters of the camera optical lens 50 in the fifth embodiment of the present disclosure in the first state and the second state, respectively.

TABLE 14

| | First state | Second state |
|---|---|---|
| fA | 22.000 | 20.250 |
| FOV | 18.23° | 16.92° |
| FNO | 2.75 | 2.81 |
| d0 | 13.675 | 11.507 |
| dp2 | 4.340 | 2.172 |
| d8 | 0.400 | 2.568 |

Table 15 shows a conic coefficient k and aspheric coefficients of the camera optical lens 50.

TABLE 15

| | Conic coefficient | Aspheric coefficient | | | | |
|---|---|---|---|---|---|---|
| | k | A4 | A6 | A8 | A10 | A12 |
| R1 | 3.30909E+01 | −4.72140E−05 | 3.99160E−07 | −1.30560E−07 | 1.40600E−08 | −9.87690E−10 |
| R2 | 0.00000E+00 | 0.00000E+00 | 0.00000E+00 | 0.00000E+00 | 0.00000E+00 | 0.00000E+00 |
| R3 | 5.50807E+00 | 7.36690E−04 | 1.58050E−05 | −1.59440E−06 | 2.84040E−07 | 1.02920E−10 |
| R4 | −5.78462E+00 | 1.75440E−03 | −3.77270E−04 | 5.04960E−05 | −4.71360E−06 | 3.17400E−07 |
| R5 | −1.99000E+02 | 6.21360E−03 | −1.11860E−03 | 1.27900E−04 | −1.13530E−05 | 7.82860E−07 |
| R6 | −1.00373E+01 | 1.77180E−03 | −5.97410E−04 | 1.14360E−04 | −1.36590E−05 | 1.09420E−06 |
| R7 | −1.47445E+01 | −3.17340E−03 | 1.12070E−03 | −1.50120E−04 | 1.33000E−05 | −8.12700E−07 |
| R8 | −1.55256E+01 | −7.99820E−03 | 1.59840E−03 | −2.44190E−04 | 2.45090E−05 | −1.73340E−06 |
| R9 | 1.71591E+02 | −7.06090E−03 | 6.34740E−04 | −4.03600E−05 | 1.28480E−06 | −4.43970E−08 |
| R10 | 3.22205E+00 | 2.44160E−04 | 3.22400E−05 | 2.43710E−06 | −2.82110E−07 | 1.84870E−08 |
| R11 | 3.18742E+00 | 7.27290E−06 | 2.90280E−05 | −9.88730E−06 | 2.04010E−06 | −2.58890E−07 |
| R12 | −4.35873E+01 | 5.45910E−04 | −7.09500E−06 | −3.83140E−06 | 2.10620E−06 | −4.61640E−07 |
| | Conic coefficient | | | | | |
| | k | A14 | A16 | A18 | A20 | / |
| R1 | 3.30909E+01 | 4.39240E−11 | −1.20980E−12 | 1.88590E−14 | −1.27520E−16 | / |
| R2 | 0.00000E+00 | 0.00000E+00 | 0.00000E+00 | 0.00000E+00 | 0.00000E+00 | / |
| R3 | 5.50807E+00 | −3.61340E−09 | 3.98500E−10 | −1.80520E−11 | 3.15260E−13 | / |
| R4 | −5.78462E+00 | −1.51680E−08 | 4.84130E−10 | −9.13800E−12 | 7.61980E−14 | / |
| R5 | −1.99000E+02 | −3.81090E−08 | 1.19370E−09 | −2.13410E−11 | 1.63940E−13 | / |
| R6 | −1.00373E+01 | −5.67360E−08 | 1.80770E−09 | −3.20160E−11 | 2.40350E−13 | / |
| R7 | −1.47445E+01 | 3.44610E−08 | −9.96680E−10 | 1.80790E−11 | −1.54080E−13 | / |
| R8 | −1.55256E+01 | 8.51980E−08 | −2.71300E−09 | 4.95230E−11 | −3.86660E−13 | / |
| R9 | 1.71591E+02 | 5.27790E−09 | −3.46540E−10 | 9.86450E−12 | −1.01760E−13 | / |
| R10 | 3.22205E+00 | −1.98260E−09 | 1.93430E−10 | −9.47720E−12 | 1.74300E−13 | / |
| R11 | 3.18742E+00 | 2.01930E−08 | −9.38370E−10 | 2.37070E−11 | −2.49050E−13 | / |
| R12 | −4.35873E+01 | 5.53270E−08 | −3.77820E−09 | 1.38290E−10 | −2.11140E−12 | / |

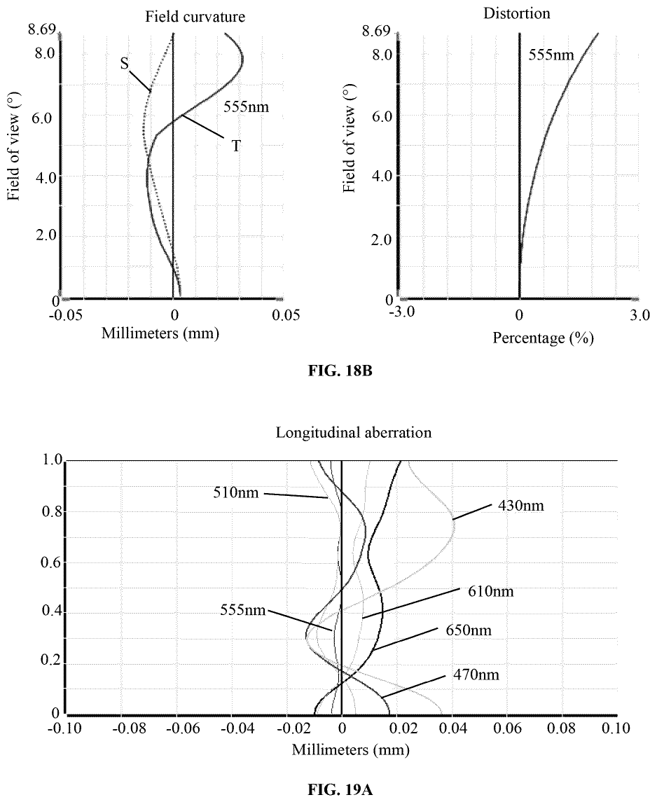

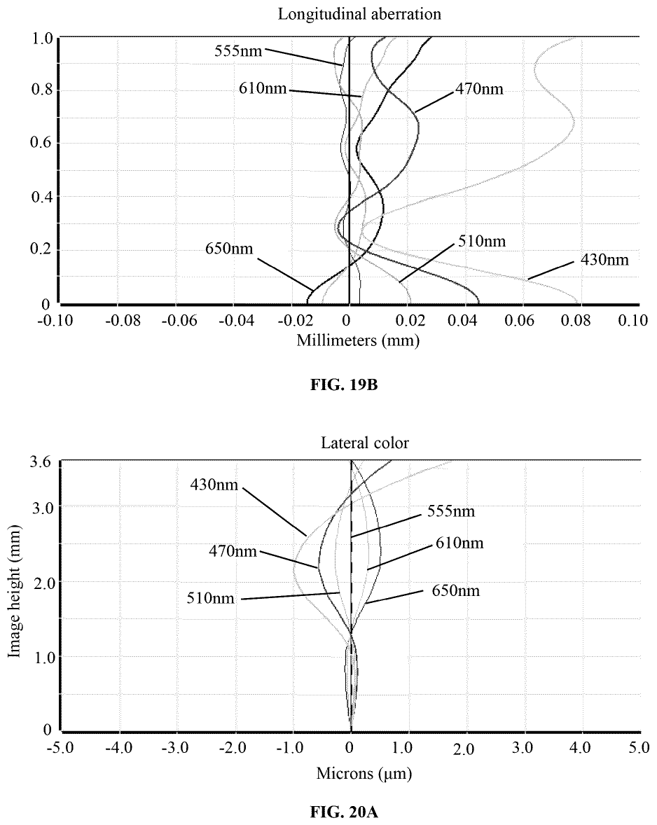

FIG. 18A and FIG. 18B show diagrams illustrating astigmatism field curvatures and distortions after light having a wavelength of 555 nm passes through the camera optical lens 50 of the fifth embodiment. FIG. 19A and FIG. 19B show diagrams illustrating longitudinal aberrations after light having wavelengths of 430 nm, 470 nm, 510 nm, 555 nm, 610 nm, and 650 nm passes through the camera optical lens 50 of the fifth embodiment. FIG. 20A and FIG. 20B show diagrams illustrating lateral colors after light having wavelengths of 430 nm, 470 nm, 510 nm, 555 nm, 610 nm, and 650 nm passes through the camera optical lens 50 of the fifth embodiment.

In this embodiment, for the camera optical lens 50 in the first state, the entrance pupil diameter (ENPD) is 8.000 mm, the full vision field image height IH is 3.600 mm, and the field of view (FOV) is 18.230. The camera optical lens 50 can achieve a large-aperture periscope design with good optical performance. Axial and off-axis chromatic aberrations of the camera optical lens 50 are fully corrected, achieving excellent optical characteristics.

### Sixth Embodiment

The first prism P1 has a positive refractive power, the object-side surface of the first prism P1 is flat in a paraxial region, and the image-side surface of the first prism P1 is flat in the paraxial region.

The first lens L1 has a positive refractive power, the object-side surface of the first lens L1 is concave in a paraxial region, and the image-side surface of the first lens L1 is convex in the paraxial region.

The second lens L2 has a positive refractive power, the object-side surface of the second lens L2 is convex in a paraxial region, and the image-side surface of the second lens L2 is convex in the paraxial region.

The third lens L3 has a negative refractive power, the object-side surface of the third lens L3 is concave in a paraxial region; the image-side surface of the third lens L3 is concave in the paraxial region.

The fourth lens L4 has a positive refractive power, the object-side surface of the fourth lens L4 is convex in a paraxial region; the image-side surface of the fourth lens L4 is convex in the paraxial region.

The fifth lens L5 has a negative refractive power, the object-side surface of the fifth lens L5 is convex in a paraxial region; the image-side surface of the fifth lens L5 is concave in the paraxial region.

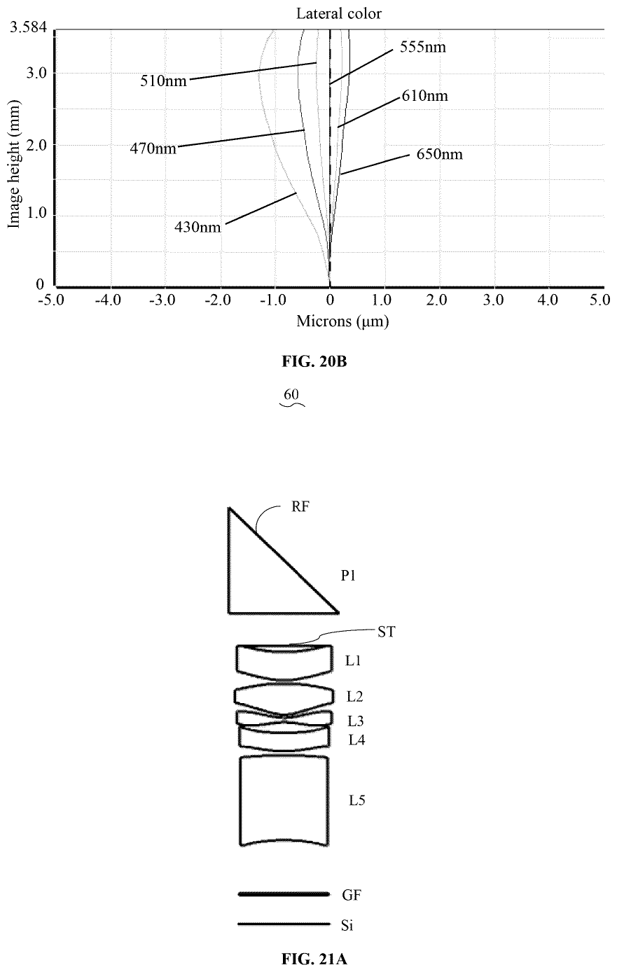

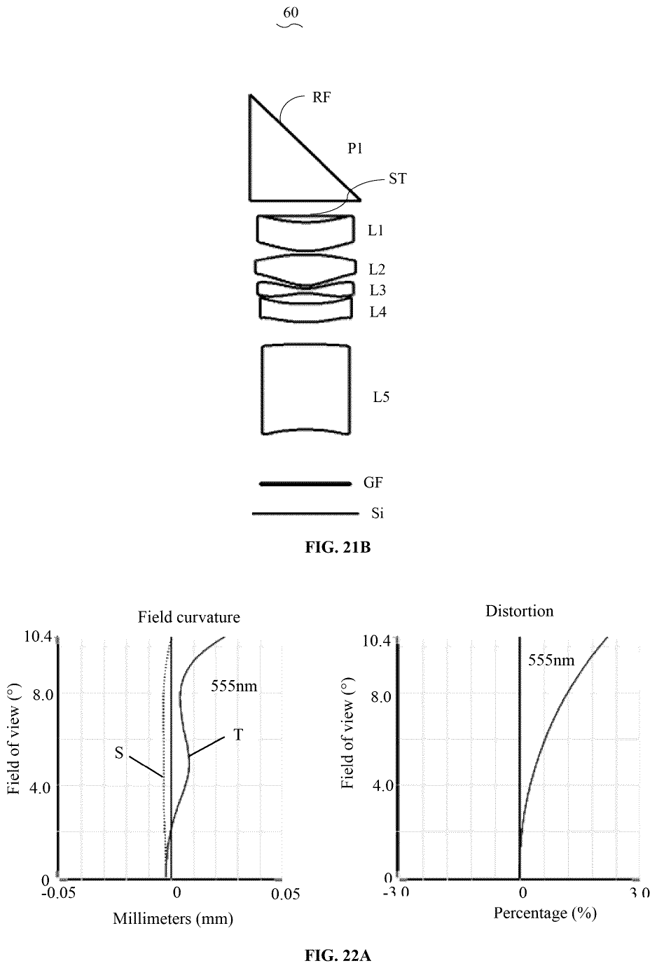

FIG. 21A and FIG. 21B are schematic structural diagrams of the camera optical lens 60 in the sixth embodiment, and the meanings of the symbols in the sixth embodiment are the same as the meanings of the symbols in the first embodiment.

Table 16 shows design data of the camera optical lens 60 in the sixth embodiment.

TABLE 16

| | R | d | | nd | | vd | |
|---|---|---|---|---|---|---|---|
| ST | ∞ | d0 | −12.770 | / | / | / | / |
| Rp1 | 200.000 | dp1 | 9.800 | nd1 | 1.8052 | vd1 | 40.89 |
| Rp2 | −363.636 | dp2 | 3.556 | | | | |
| R1 | −11.500 | d1 | 2.626 | nd2 | 1.6400 | vd2 | 23.54 |
| R2 | −6.230 | d2 | 0.319 | | | | |
| R3 | 36.883 | d3 | 2.838 | nd3 | 1.5444 | vd3 | 55.82 |
| R4 | −2.895 | d4 | 0.279 | | | | |
| R5 | −4.425 | d5 | 0.407 | nd4 | 1.6153 | vd4 | 25.94 |
| R6 | 4.199 | d6 | 0.979 | | | | |
| R7 | 303.532 | d7 | 1.708 | nd5 | 1.6700 | vd5 | 19.39 |
| R8 | −11.757 | d8 | 0.400 | | | | |
| R9 | 46.824 | d9 | 7.815 | nd6 | 1.5346 | vd6 | 55.69 |
| R10 | 16.544 | d10 | 4.877 | | | | |
| R11 | ∞ | d11 | 0.210 | ndg | 1.5168 | vdg | 64.17 |
| R12 | ∞ | d12 | 2.651 | | | | |

In the Table 16, dp1=“dp1-01”+“dp1-02”, “dp1-01”=5.000, and “dp1-02”=4.800.

Table 17 lists data of relevant optical parameters of the camera optical lens 60 in the sixth embodiment of the present disclosure in the first state and the second state, respectively.

TABLE 17

| | First state | Second state |
|---|---|---|
| fA | 19.203 | 20.850 |
| FOV | 20.79° | 18.96° |
| FNO | 2.40 | 2.51 |
| d0 | 12.770 | 10.622 |
| dp2 | 3.556 | 1.408 |
| d8 | 0.400 | 2.548 |

Table 18 shows a conic coefficient k and aspheric coefficients of the camera optical lens 60.

TABLE 18

| | Conic coefficient | Aspheric coefficient | | | | |
|---|---|---|---|---|---|---|
| | k | A4 | A6 | A8 | A10 | A12 |
| R1 | 1.35715E+02 | −1.95010E−05 | 1.18610E−06 | −1.56430E−07 | 1.50320E−08 | −9.91040E−10 |
| R2 | 0.00000E+00 | 0.00000E+00 | 0.00000E+00 | 0.00000E+00 | 0.00000E+00 | 0.00000E+00 |
| R3 | 5.68244E+00 | 8.06450E−04 | 2.35850E−05 | −2.72240E−06 | 3.32910E−07 | 3.91320E−09 |
| R4 | −1.14486E+01 | 1.20440E−03 | −3.75700E−04 | 5.13530E−05 | −4.69360E−06 | 3.17040E−07 |
| R5 | 4.76612E+01 | 6.37840E−03 | −1.11410E−03 | 1.27480E−04 | −1.13810E−05 | 7.82310E−07 |
| R6 | −8.73189E+00 | 1.63760E−03 | −5.87670E−04 | 1.14240E−04 | −1.36760E−05 | 1.09330E−06 |
| R7 | −1.50630E+01 | −3.66750E−03 | 1.12900E−03 | −1.49150E−04 | 1.33160E−05 | −8.13570E−07 |
| R8 | −2.02172E+01 | −7.31250E−03 | 1.59670E−03 | −2.44680E−04 | 2.45090E−05 | −1.73260E−06 |
| R9 | 1.99000E+02 | −7.11880E−03 | 6.56790E−04 | −3.92950E−05 | 1.29740E−06 | −4.48250E−08 |
| R10 | 4.85613E+00 | 6.13980E−05 | 8.47520E−05 | 3.75700E−06 | −2.88120E−07 | 1.85860E−08 |
| R11 | 2.48198E+01 | 3.13230E−05 | 2.64930E−05 | −9.75800E−06 | 2.04060E−06 | −2.58840E−07 |
| R12 | −9.99815E+00 | 7.00980E−04 | 2.83760E−05 | −1.15340E−05 | 2.93850E−06 | −4.89530E−07 |
| | Conic coefficient | | | | | |
| | k | A14 | A16 | A18 | A20 | / |
| R1 | 1.35715E+02 | 4.34400E−11 | −1.21270E−12 | 1.95120E−14 | −1.37670E−16 | / |
| R2 | 0.00000E+00 | 0.00000E+00 | 0.00000E+00 | 0.00000E+00 | 0.00000E+00 | / |
| R3 | 5.68244E+00 | −3.58400E−09 | 3.83880E−10 | −1.84570E−11 | 3.56850E−13 | / |
| R4 | −1.14486E+01 | −1.52010E−08 | 4.82750E−10 | −9.13410E−12 | 7.98690E−14 | / |
| R5 | 4.76612E+01 | −3.81120E−08 | 1.19420E−09 | −2.13140E−11 | 1.64050E−13 | / |
| R6 | −8.73189E+00 | −5.67620E−08 | 1.80750E−09 | −3.20110E−11 | 2.41680E−13 | / |
| R7 | −1.50630E+01 | 3.43840E−08 | −9.99500E−10 | 1.80540E−11 | −1.49060E−13 | / |
| R8 | −2.02172E+01 | 8.52280E−08 | −2.71320E−09 | 4.94510E−11 | −3.86100E−13 | / |
| R9 | 1.99000E+02 | 5.25880E−09 | −3.45520E−10 | 9.93180E−12 | −1.04410E−13 | / |
| R10 | 4.85613E+00 | −1.90010E−09 | 1.95260E−10 | −9.68950E−12 | 1.72640E−13 | / |
| R11 | 2.48198E+01 | 2.01630E−08 | −9.38240E−10 | 2.37750E−11 | −2.50230E−13 | / |
| R12 | −9.99815E+00 | 5.39610E−08 | −3.75200E−09 | 1.47080E−10 | −2.44880E−12 | / |

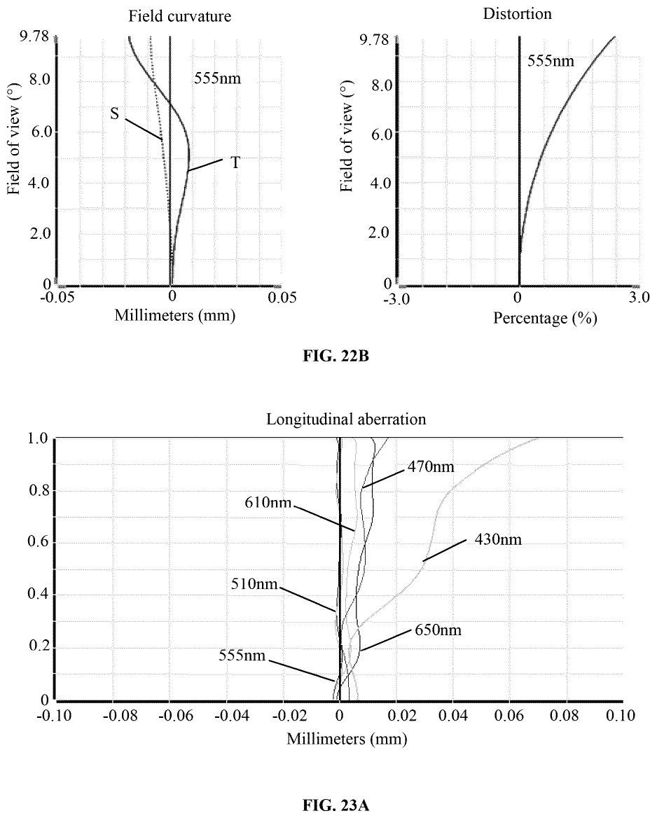

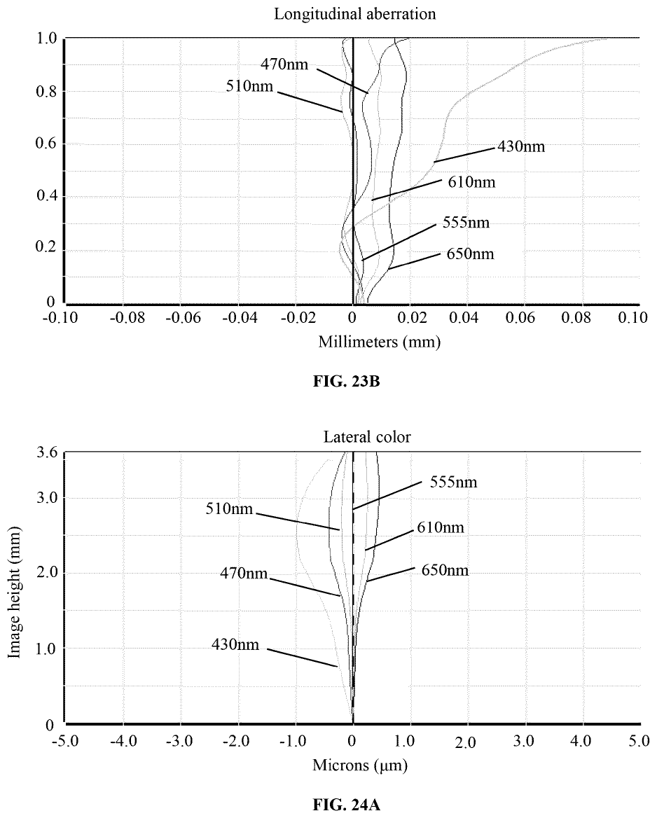

FIG. 22A and FIG. 22B show diagrams illustrating astigmatism field curvatures and distortions after light having a wavelength of 555 nm passes through the camera optical lens 60 of the sixth embodiment. FIG. 23A and FIG. 23B show diagrams illustrating longitudinal aberrations after light having wavelengths of 430 nm, 470 nm, 510 nm, 555 nm, 610 nm, and 650 nm passes through the camera optical lens 60 of the sixth embodiment. FIG. 24A and FIG. 24B show diagrams illustrating lateral colors after light having wavelengths of 430 nm, 470 nm, 510 nm, 555 nm, 610 nm, and 650 nm passes through the camera optical lens 60 of the sixth embodiment.

In this embodiment, for the camera optical lens 60 in the first state, the entrance pupil diameter (ENPD) is 8.000 mm, the full vision field image height IH is 3.600 mm, and the field of view (FOV) is 20.79°. The camera optical lens 60 can achieve a large-aperture periscope design with good optical performance. Axial and off-axis chromatic aberrations of the camera optical lens 60 are fully corrected, achieving excellent optical characteristics.

### Seventh Embodiment

The first prism P1 has a positive refractive power, the object-side surface of the first prism P1 is flat in a paraxial region, and the image-side surface of the first prism P1 is convex in the paraxial region.

The first lens L1 has a positive refractive power, the object-side surface of the first lens L1 is concave in a paraxial region, and the image-side surface of the first lens L1 is convex in the paraxial region.

The second lens L2 has a positive refractive power, the object-side surface of the second lens L2 is convex in a paraxial region, and the image-side surface of the second lens L2 is convex in the paraxial region.

The third lens L3 has a negative refractive power, the object-side surface of the third lens L3 is concave in a paraxial region; the image-side surface of the third lens L3 is concave in the paraxial region.

The fourth lens L4 has a positive refractive power, the object-side surface of the fourth lens L4 is convex in a paraxial region; the image-side surface of the fourth lens L4 is convex in the paraxial region.

The fifth lens L5 has a negative refractive power, the object-side surface of the fifth lens L5 is convex in a paraxial region; the image-side surface of the fifth lens L5 is concave in the paraxial region.

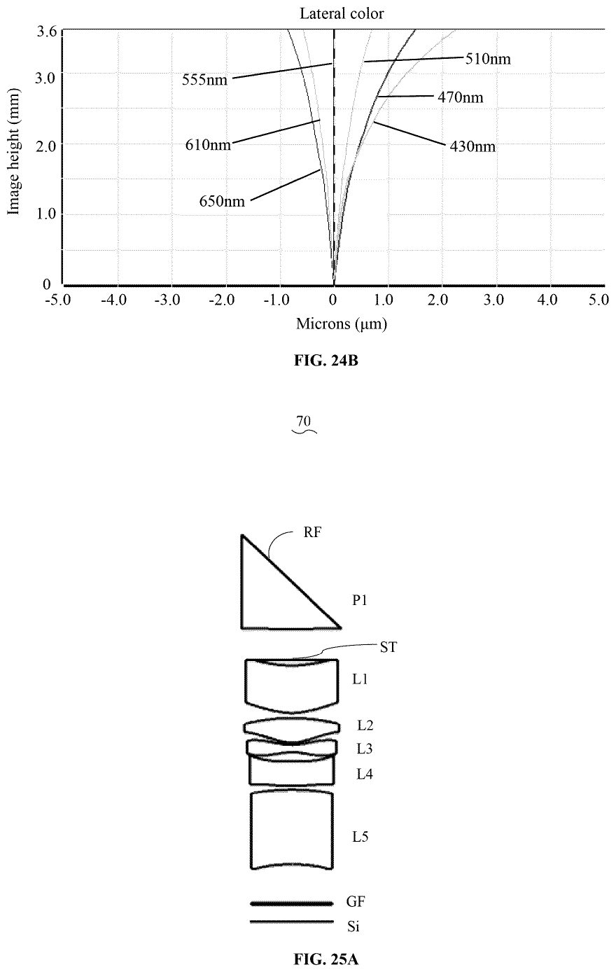

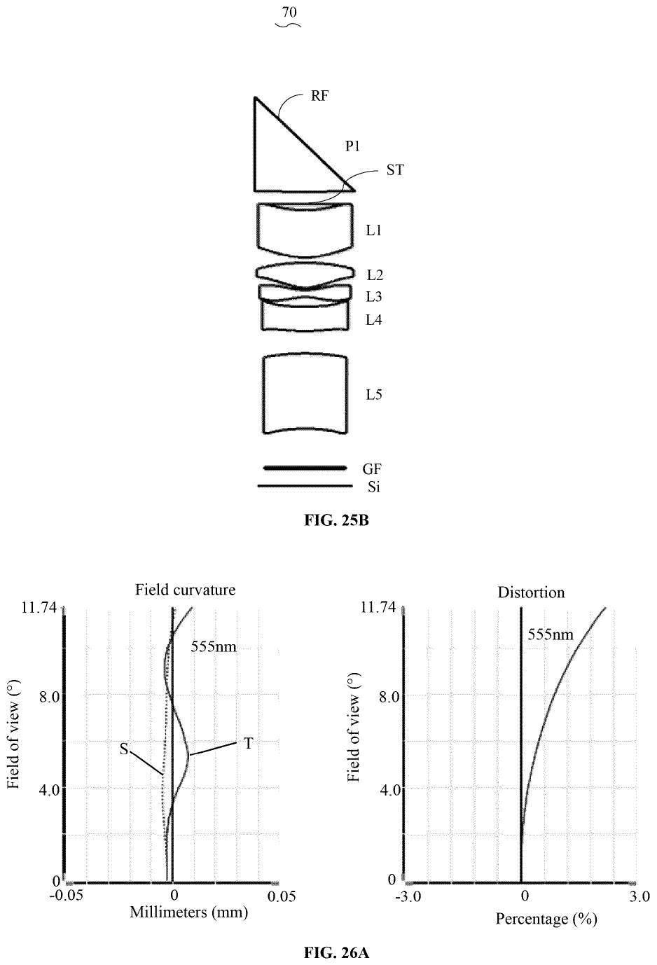

FIG. 25A and FIG. 25B are schematic structural diagrams of the camera optical lens 70 in the seventh embodiment, and the meanings of the symbols in the seventh embodiment are the same as the meanings of the symbols in the first embodiment.

Table 19 shows design data of the camera optical lens 70 in the seventh embodiment.

TABLE 19

| | R | d | | nd | | vd | |
|---|---|---|---|---|---|---|---|
| ST | ∞ | d0 | −12.964 | / | / | / | / |
| Rp1 | 204.659 | dp1 | 9.800 | nd1 | 1.8052 | vd1 | 40.89 |
| Rp2 | −163.772 | dp2 | 3.775 | | | | |
| R1 | −11.381 | d1 | 4.881 | nd2 | 1.6400 | vd2 | 23.54 |
| R2 | −5.864 | d2 | 0.545 | | | | |
| R3 | 58.200 | d3 | 2.553 | nd3 | 1.5444 | vd3 | 55.82 |
| R4 | −2.853 | d4 | 0.204 | | | | |
| R5 | −5.296 | d5 | 0.744 | nd4 | 1.6153 | vd4 | 25.94 |
| R6 | 3.535 | d6 | 0.957 | | | | |
| R7 | 72.798 | d7 | 2.524 | nd5 | 1.6700 | vd5 | 19.39 |
| R8 | −19.585 | d8 | 0.400 | | | | |
| R9 | 21.521 | d9 | 7.718 | nd6 | 1.5346 | vd6 | 55.69 |
| R10 | 17.320 | d10 | 3.958 | | | | |
| R11 | ∞ | d11 | 0.210 | ndg | 1.5168 | vdg | 64.17 |
| R12 | ∞ | d12 | 1.732 | | | | |

In the Table 19, dp1=“dp1-01”+“dp1-02”, “dp1-01”=5.000, and “dp1-02”=4.800.

Table 20 lists data of relevant optical parameters of the camera optical lens 70 in the seventh embodiment of the present disclosure in the first state and the second state, respectively.

TABLE 20

| | First state | Second state |
|---|---|---|
| fA | 16.948 | 25.650 |
| FOV | 23.48° | 22.84° |
| FNO | 2.12 | 2.16 |
| d0 | 12.964 | 10.886 |
| dp2 | 3.775 | 1.697 |
| d8 | 0.400 | 2.478 |

Table 21 shows a conic coefficient k and aspheric coefficients of the camera optical lens 70.

TABLE 21

| | Conic coefficient | Aspheric coefficient | | | | |
|---|---|---|---|---|---|---|
| | k | A4 | A6 | A8 | A10 | A12 |
| R1 | 1.32654E+02 | −2.17340E−05 | 9.77680E−07 | −1.35400E−07 | 1.40480E−08 | −9.79780E−10 |
| R2 | 0.00000E+00 | 0.00000E+00 | 0.00000E+00 | 0.00000E+00 | 0.00000E+00 | 0.00000E+00 |
| R3 | 5.59713E+00 | 7.55210E−04 | 1.88850E−05 | −2.14380E−06 | 3.15770E−07 | 2.01380E−09 |
| R4 | −8.26043E+00 | 1.30520E−03 | −3.73890E−04 | 5.10610E−05 | −4.71240E−06 | 3.16720E−07 |
| R5 | 6.94498E+01 | 6.47350E−03 | −1.11540E−03 | 1.27660E−04 | −1.13620E−05 | 7.82800E−07 |
| R6 | −8.37839E+00 | 1.72130E−03 | −5.93120E−04 | 1.14280E−04 | −1.36690E−05 | 1.09380E−06 |
| R7 | −1.73160E+01 | −3.36470E−03 | 1.12840E−03 | −1.50000E−04 | 1.32890E−05 | −8.13380E−07 |
| R8 | −1.45209E+01 | −7.54210E−03 | 1.59140E−03 | −2.44470E−04 | 2.45110E−05 | −1.73300E−06 |
| R9 | 1.99000E+02 | −7.11750E−03 | 6.49970E−04 | −3.98880E−05 | 1.28630E−06 | −4.45230E−08 |
| R10 | 5.22736E+00 | 1.57810E−04 | 6.03620E−05 | 2.96530E−06 | −2.94730E−07 | 1.83330E−08 |
| R11 | 4.66953E+00 | −6.55700E−06 | 2.57180E−05 | −9.69250E−06 | 2.05080E−06 | −2.60110E−07 |
| R12 | −2.30483E+00 | 5.79430E−04 | 1.78370E−05 | −8.24250E−06 | 2.60370E−06 | −4.84300E−07 |
| | Conic coefficient | | | | | |
| | k | A14 | A16 | A18 | A20 | / |
| R1 | 1.32654E+02 | 4.39910E−11 | −1.21680E−12 | 1.88290E−14 | −1.24590E−16 | / |
| R2 | 0.00000E+00 | 0.00000E+00 | 0.00000E+00 | 0.00000E+00 | 0.00000E+00 | / |
| R3 | 5.59713E+00 | −3.60130E−09 | 3.88250E−10 | −1.81820E−11 | 3.43810E−13 | / |
| R4 | −8.26043E+00 | −1.51860E−08 | 4.84530E−10 | −9.09310E−12 | 7.53190E−14 | / |
| R5 | 6.94498E+01 | −3.81090E−08 | 1.19360E−09 | −2.13390E−11 | 1.64480E−13 | / |
| R6 | −8.37839E+00 | −5.67450E−08 | 1.80760E−09 | −3.20170E−11 | 2.40880E−13 | / |
| R7 | −1.73160E+01 | 3.44390E−08 | −9.97150E−10 | 1.80760E−11 | −1.52680E−13 | / |
| R8 | −1.45209E+01 | 8.52090E−08 | −2.71290E−09 | 4.95030E−11 | −3.88460E−13 | / |
| R9 | 1.99000E+02 | 5.27430E−09 | −3.46740E−10 | 9.85370E−12 | −1.01860E−13 | / |
| R10 | 5.22736E+00 | −1.96750E−09 | 1.93950E−10 | −9.54150E−12 | 1.71820E−13 | / |
| R11 | 4.66953E+00 | 2.01640E−08 | −9.36080E−10 | 2.38930E−11 | −2.57860E−13 | / |
| R12 | −2.30483E+00 | 5.52420E−08 | −3.76340E−09 | 1.40130E−10 | −2.18940E−12 | / |

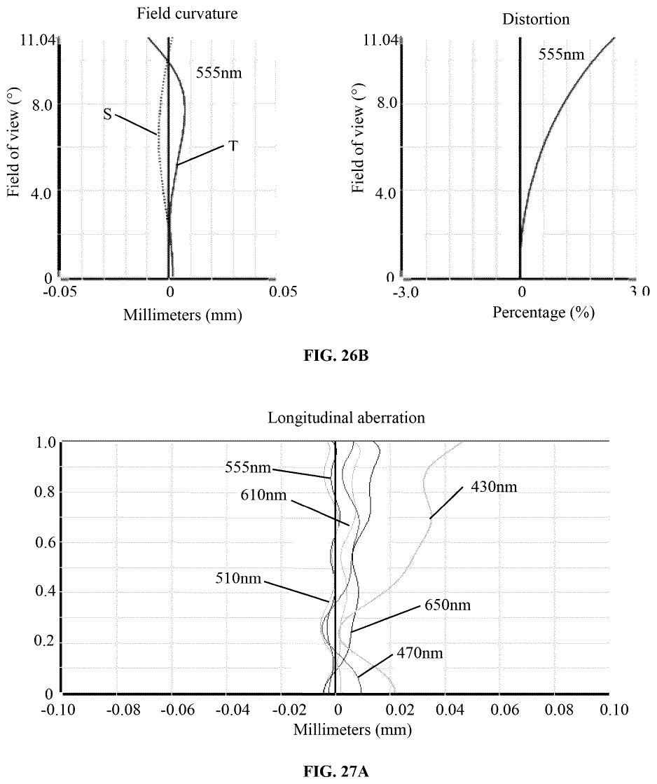

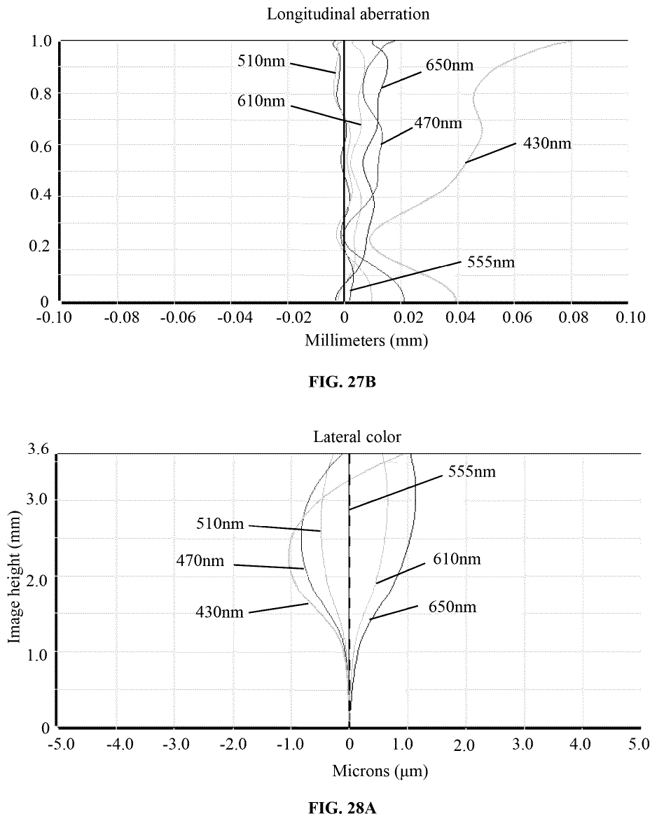

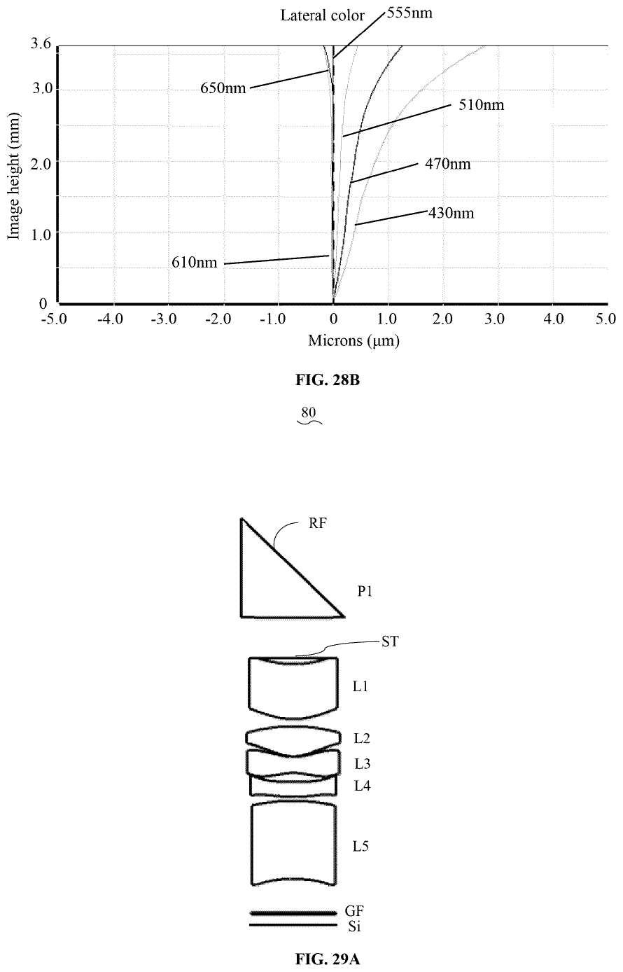

FIG. 26A and FIG. 26B show diagrams illustrating astigmatism field curvatures and distortions after light having a wavelength of 555 nm passes through the camera optical lens 70 of the seventh embodiment. FIG. 27A and FIG. 27B show diagrams illustrating longitudinal aberrations after light having wavelengths of 430 nm, 470 nm, 510 nm, 555 nm, 610 nm, and 650 nm passes through the camera optical lens 70 of the seventh embodiment. FIG. 28A and FIG. 28B show diagrams illustrating lateral colors after light having wavelengths of 430 nm, 470 nm, 510 nm, 555 nm, 610 nm, and 650 nm passes through the camera optical lens 70 of the seventh embodiment.

In this embodiment, for the camera optical lens 70 in the first state, the entrance pupil diameter (ENPD) is 8.013 mm, the full vision field image height IH is 3.600 mm, and the field of view (FOV) is 23.48°. The camera optical lens 70 can achieve a large-aperture periscope design with good optical performance. Axial and off-axis chromatic aberrations of the camera optical lens 70 are fully corrected, achieving excellent optical characteristics.

### Eighth Embodiment

The first prism P1 has a positive refractive power, the object-side surface of the first prism P1 is flat in a paraxial region, and the image-side surface of the first prism P1 is convex in the paraxial region.

The first lens L1 has a positive refractive power, the object-side surface of the first lens L1 is concave in a paraxial region, and the image-side surface of the first lens L1 is convex in the paraxial region.

The second lens L2 has a positive refractive power, the object-side surface of the second lens L2 is convex in a paraxial region, and the image-side surface of the second lens L2 is convex in the paraxial region.

The third lens L3 has a negative refractive power, the object-side surface of the third lens L3 is concave in a paraxial region; the image-side surface of the third lens L3 is concave in the paraxial region.

The fourth lens L4 has a positive refractive power, the object-side surface of the fourth lens L4 is convex in a paraxial region; the image-side surface of the fourth lens L4 is convex in the paraxial region.

The fifth lens L5 has a negative refractive power, the object-side surface of the fifth lens L5 is convex in a paraxial region; the image-side surface of the fifth lens L5 is concave in the paraxial region.

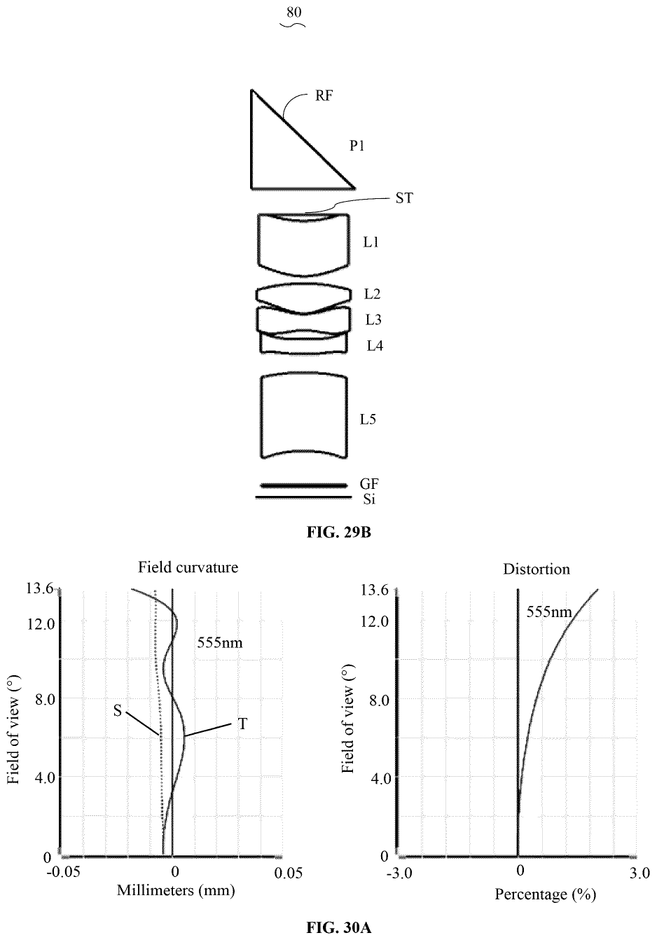

FIG. 29A and FIG. 29B are schematic structural diagrams of the camera optical lens 80 in the eighth embodiment, and the meanings of the symbols in the eighth embodiment are the same as the meanings of the symbols in the first embodiment.

Table 22 shows design data of the camera optical lens 80 in the eighth embodiment.

TABLE 22

| | R | d | | nd | | vd | |
|---|---|---|---|---|---|---|---|
| ST | ∞ | d0 | −13.752 | / | / | / | / |
| Rp1 | 400.000 | dp1 | 9.800 | nd1 | 1.8052 | vd1 | 40.89 |
| Rp2 | −166.667 | dp2 | 4.540 | | | | |
| R1 | −9.495 | d1 | 5.413 | nd2 | 1.6400 | vd2 | 23.54 |
| R2 | −5.725 | d2 | 0.710 | | | | |
| R3 | 35.645 | d3 | 2.953 | nd3 | 1.5444 | vd3 | 55.82 |
| R4 | −2.865 | d4 | 0.050 | | | | |
| R5 | −4.526 | d5 | 1.561 | nd4 | 1.6153 | vd4 | 25.94 |
| R6 | 4.220 | d6 | 0.863 | | | | |
| R7 | 85.609 | d7 | 1.459 | nd5 | 1.6700 | vd5 | 19.39 |
| R8 | −17.505 | d8 | 0.400 | | | | |
| R9 | 17.409 | d9 | 7.688 | nd6 | 1.5346 | vd6 | 55.69 |
| R10 | 12.803 | d10 | 3.260 | | | | |
| R11 | ∞ | d11 | 0.210 | ndg | 1.5168 | vdg | 64.17 |
| R12 | ∞ | d12 | 1.030 | | | | |

In the Table 23, dp1=“dp1-01”+“dp1-02”, “dp1-01”=5.000, and “dp1-02”=4.800.

Table 23 lists data of relevant optical parameters of the camera optical lens 80 in the eighth embodiment of the present disclosure in the first state and the second state, respectively.

TABLE 23

| | First state | Second state |
|---|---|---|
| fA | 14.580 | 25.560 |
| FOV | 27.20° | 25.74° |
| FNO | 2.12 | 2.16 |
| d0 | 13.752 | 11.683 |
| dp2 | 4.540 | 2.471 |
| d8 | 0.400 | 2.469 |

Table 24 shows a conic coefficient k and aspheric coefficients of the camera optical lens 80.

TABLE 24

| | Conic coefficient | Aspheric coefficient | | | | |
|---|---|---|---|---|---|---|
| | k | A4 | A6 | A8 | A10 | A12 |
| R1 | 1.03148E+03 | −1.73330E−05 | 5.99090E−07 | −1.04290E−07 | 1.29680E−08 | −9.71440E−10 |
| R2 | 0.00000E+00 | 0.00000E+00 | 0.00000E+00 | 0.00000E+00 | 0.00000E+00 | 0.00000E+00 |
| R3 | 4.58414E+00 | 8.04770E−04 | 3.62350E−05 | −2.47500E−06 | 4.24610E−07 | 4.99250E−09 |
| R4 | −6.85754E+00 | 9.05920E−04 | −3.61920E−04 | 5.14830E−05 | −4.72060E−06 | 3.15820E−07 |
| R5 | 4.24528E+01 | 6.36080E−03 | −1.11410E−03 | 1.27380E−04 | −1.13730E−05 | 7.82900E−07 |
| R6 | −6.17663E+00 | 1.75970E−03 | −6.06930E−04 | 1.14370E−04 | −1.36570E−05 | 1.09380E−06 |
| R7 | −1.10118E+01 | −3.89480E−03 | 1.15170E−03 | −1.49530E−04 | 1.32910E−05 | −8.13290E−07 |
| R8 | −1.38897E+01 | −7.44840E−03 | 1.57000E−03 | −2.45350E−04 | 2.45120E−05 | −1.73140E−06 |
| R9 | −1.99000E+02 | −7.42160E−03 | 6.60140E−04 | −4.00140E−05 | 1.26350E−06 | −4.53020E−08 |
| R10 | 5.67848E+00 | −1.26850E−04 | 8.09340E−05 | 6.29690E−06 | −3.74600E−07 | 1.17240E−08 |
| R11 | 3.91637E+00 | −8.09490E−05 | 3.15440E−05 | −1.03330E−05 | 2.06220E−06 | −2.58380E−07 |
| R12 | −4.04833E+00 | 7.84750E−04 | 2.24880E−05 | −5.76830E−06 | 2.24880E−06 | −4.70660E−07 |
| | Conic coefficient | | | | | |
| | k | A14 | A16 | A18 | A20 | / |
| R1 | 1.03148E+03 | 4.43630E−11 | −1.22080E−12 | 1.87370E−14 | −1.24200E−16 | / |
| R2 | 0.00000E+00 | 0.00000E+00 | 0.00000E+00 | 0.00000E+00 | 0.00000E+00 | / |
| R3 | 4.58414E+00 | −3.74160E−09 | 3.69450E−10 | −1.82720E−11 | 5.01220E−13 | / |
| R4 | −6.85754E+00 | −1.52010E−08 | 4.85660E−10 | −9.02560E−12 | 7.29770E−14 | / |
| R5 | 4.24528E+01 | −3.80980E−08 | 1.19400E−09 | −2.13390E−11 | 1.64430E−13 | / |
| R6 | −6.17663E+00 | −5.67460E−08 | 1.80790E−09 | −3.20050E−11 | 2.40900E−13 | / |
| R7 | −1.10118E+01 | 3.44420E−08 | −9.97160E−10 | 1.80680E−11 | −1.53060E−13 | / |
| R8 | −1.38897E+01 | 8.52780E−08 | −2.71270E−09 | 4.94540E−11 | −3.87950E−13 | / |
| R9 | −1.99000E+02 | 5.29690E−09 | −3.43400E−10 | 9.92370E−12 | −1.05340E−13 | / |
| R10 | 5.67848E+00 | −1.90370E−09 | 2.06580E−10 | −9.47990E−12 | 1.56850E−13 | / |
| R11 | 3.91637E+00 | 2.01030E−08 | −9.39000E−10 | 2.40770E−11 | −2.60540E−13 | / |
| R12 | −4.04833E+00 | 5.61750E−08 | −3.77990E−09 | 1.32600E−10 | −1.86830E−12 | / |

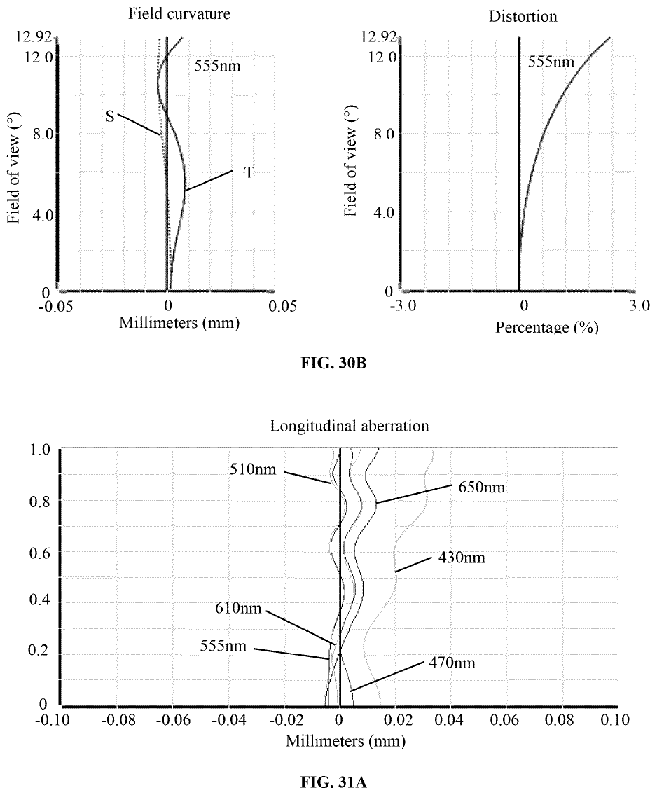

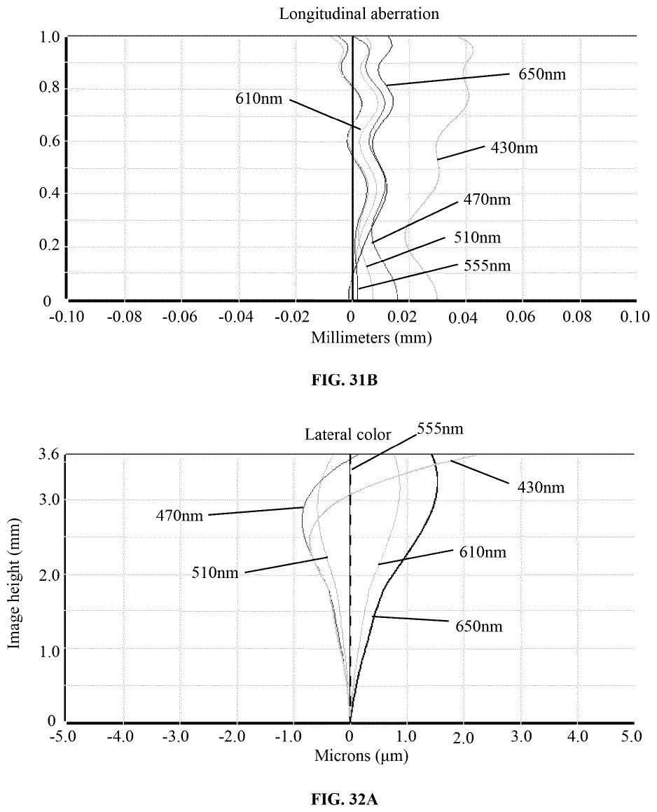

FIGS. 30A and FIG. 30B show diagrams illustrating astigmatism field curvatures and distortions after light having a wavelength of 555 nm passes through the camera optical lens 80 of the eighth embodiment. FIG. 31A and FIG. 31B show diagrams illustrating longitudinal aberrations after light having wavelengths of 430 nm, 470 nm, 510 nm, 555 nm, 610 nm, and 650 nm passes through the camera optical lens 80 of the eighth embodiment. FIG. 32A and FIG. 32B show diagrams illustrating lateral colors after light having wavelengths of 430 nm, 470 nm, 510 nm, 555 nm, 610 nm, and 650 nm passes through the camera optical lens 80 of the eighth embodiment.

In this embodiment, for the camera optical lens 80 in the first state, the entrance pupil diameter (ENPD) is 6.894 mm, the full vision field image height IH is 3.600 mm, and the field of view (FOV) is 27.200. The camera optical lens 80 can achieve a large-aperture periscope design with good optical performance. Axial and off-axis chromatic aberrations of the camera optical lens 80 are fully corrected, achieving excellent optical characteristics.

### Ninth Embodiment

The first prism P1 has a positive refractive power, the object-side surface of the first prism P1 is flat in a paraxial region, and the image-side surface of the first prism P1 is convex in the paraxial region.

The first lens L1 has a positive refractive power, the object-side surface of the first lens L1 is concave in a paraxial region, and the image-side surface of the first lens L1 is convex in the paraxial region.

The second lens L2 has a positive refractive power, the object-side surface of the second lens L2 is convex in a paraxial region, and the image-side surface of the second lens L2 is convex in the paraxial region.

The third lens L3 has a negative refractive power, the object-side surface of the third lens L3 is concave in a paraxial region; the image-side surface of the third lens L3 is concave in the paraxial region.

The fourth lens L4 has a positive refractive power, the object-side surface of the fourth lens L4 is convex in a paraxial region; the image-side surface of the fourth lens L4 is convex in the paraxial region.

The fifth lens L5 has a negative refractive power, the object-side surface of the fifth lens L5 is convex in a paraxial region; the image-side surface of the fifth lens L5 is concave in the paraxial region.

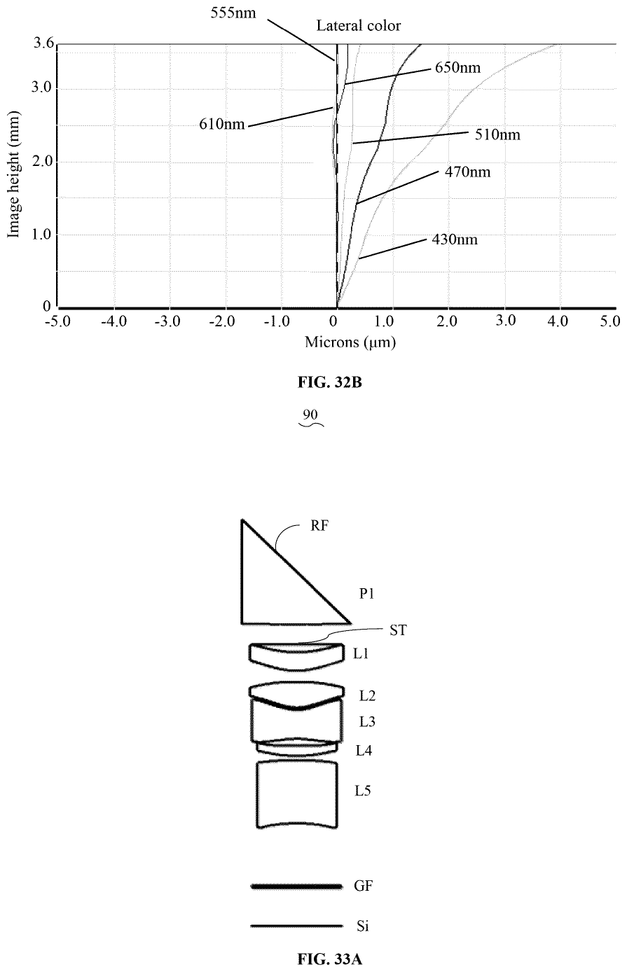

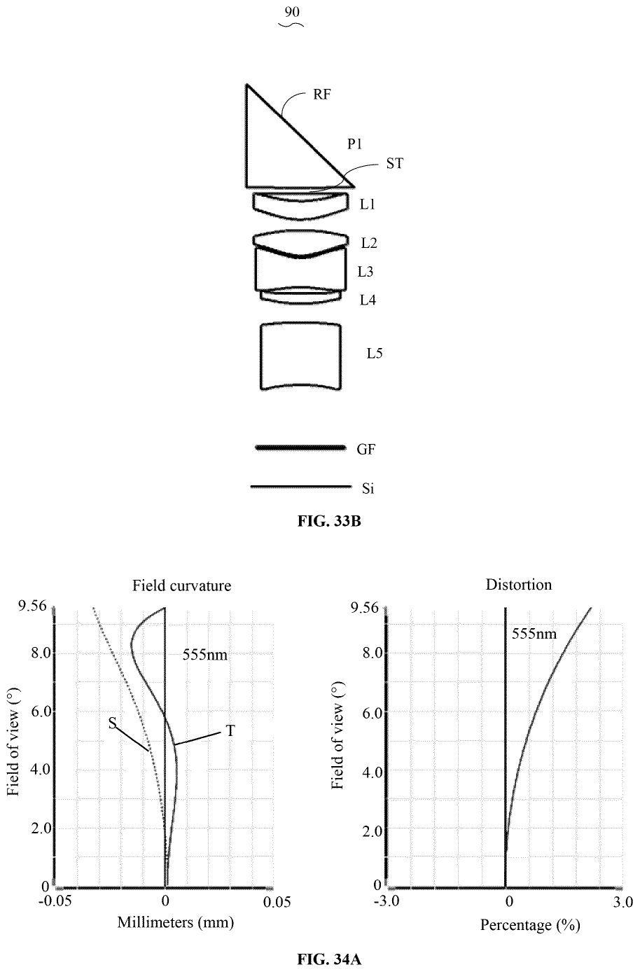

FIG. 33A and FIG. 33B are schematic structural diagrams of the camera optical lens 90 in the ninth embodiment, and the meanings of the symbols in the ninth embodiment are the same as the meanings of the symbols in the first embodiment.

Table 25 shows design data of the camera optical lens 90 in the ninth embodiment.

TABLE 25

| | R | d | | nd | | vd | |
|---|---|---|---|---|---|---|---|
| ST | ∞ | d0 | −11.672 | / | / | / | / |
| Rp1 | 400.000 | dp1 | 9.800 | nd1 | 1.8052 | vd1 | 40.89 |
| Rp2 | −105.263 | dp2 | 2.581 | | | | |
| R1 | −9.681 | d1 | 1.731 | nd2 | 1.6400 | vd2 | 23.54 |
| R2 | −6.158 | d2 | 1.024 | | | | |
| R3 | 38.701 | d3 | 2.382 | nd3 | 1.5444 | vd3 | 55.82 |
| R4 | −3.227 | d4 | 0.216 | | | | |
| R5 | −3.285 | d5 | 2.696 | nd4 | 1.6153 | vd4 | 25.94 |
| R6 | 6.745 | d6 | 0.614 | | | | |
| R7 | 18.178 | d7 | 0.965 | nd5 | 1.6700 | vd5 | 19.39 |
| R8 | −15.010 | d8 | 0.400 | | | | |
| R9 | 28.009 | d9 | 5.866 | nd6 | 1.5346 | vd6 | 55.69 |
| R10 | 14.717 | d10 | 5.778 | | | | |
| R11 | ∞ | d11 | 0.210 | ndg | 1.5168 | vdg | 64.17 |
| R12 | ∞ | d12 | 3.553 | | | | |

In the Table 25, dp1=“dp1-01”+“dp1-02”, “dp1-01”=5.000, and “dp1-02”=4.800.

Table 26 lists data of relevant optical parameters of the camera optical lens 90 in the ninth embodiment of the present disclosure in the first state and the second state, respectively.

TABLE 26

| | First state | Second state |
|---|---|---|
| fA | 20.919 | 19.360 |
| FOV | 19.12° | 18.43° |
| FNO | 2.52 | 2.61 |
| d0 | 11.672 | 9.657 |
| dp2 | 2.581 | 0.566 |
| d8 | 0.400 | 2.415 |

Table 27 shows a conic coefficient k and aspheric coefficients of the camera optical lens 90.

TABLE 27

| | Conic coefficient | Aspheric coefficient | | | | |
|---|---|---|---|---|---|---|
| | k | A4 | A6 | A8 | A10 | A12 |
| R1 | −6.45976E+02 | −1.57210E−05 | −4.64560E−07 | −6.48250E−08 | 1.35240E−08 | −1.00830E−09 |
| R2 | 0.00000E+00 | 0.00000E+00 | 0.00000E+00 | 0.00000E+00 | 0.00000E+00 | 0.00000E+00 |
| R3 | 3.52037E+00 | 7.59600E−04 | 5.66320E−05 | −3.21360E−06 | 3.24220E−07 | 2.92240E−09 |
| R4 | −5.00342E+00 | 1.24590E−03 | −3.54970E−04 | 5.09040E−05 | −4.70890E−06 | 3.17980E−07 |
| R5 | −8.75566E+01 | 6.62600E−03 | −1.11280E−03 | 1.27820E−04 | −1.13860E−05 | 7.81900E−07 |
| R6 | −8.04946E+00 | 1.81080E−03 | −6.22730E−04 | 1.14870E−04 | −1.36290E−05 | 1.09310E−06 |
| R7 | −9.07430E+00 | −4.53980E−03 | 1.13950E−03 | −1.49620E−04 | 1.33200E−05 | −8.11440E−07 |
| R8 | −1.69697E+01 | −6.57050E−03 | 1.61090E−03 | −2.45370E−04 | 2.43790E−05 | −1.73470E−06 |
| R9 | −1.30214E+02 | −7.11430E−03 | 6.68180E−04 | −3.98030E−05 | 1.32940E−06 | −4.44240E−08 |
| R10 | 8.14871E+00 | −1.29690E−03 | 4.52000E−05 | 9.56540E−06 | −3.56250E−07 | 1.11500E−08 |
| R11 | 1.16028E+01 | 5.10140E−05 | 2.91930E−05 | −1.02570E−05 | 2.07500E−06 | −2.58460E−07 |
| R12 | −3.21481E+01 | 1.63030E−03 | −1.19470E−05 | −1.23580E−05 | 3.10020E−06 | −4.67440E−07 |
| | Conic coefficient | | | | | |
| | k | A14 | A16 | A18 | A20 | / |
| R1 | −6.45976E+02 | 4.24380E−11 | −1.13590E−12 | 1.91590E−14 | −1.57910E−16 | / |
| R2 | 0.00000E+00 | 0.00000E+00 | 0.00000E+00 | 0.00000E+00 | 0.00000E+00 | / |
| R3 | 3.52037E+00 | −3.58690E−09 | 3.88820E−10 | −1.81610E−11 | 3.32140E−13 | / |
| R4 | −5.00342E+00 | −1.51620E−08 | 4.82120E−10 | −9.22860E−12 | 8.16960E−14 | / |
| R5 | −8.75566E+01 | −3.81130E−08 | 1.19490E−09 | −2.13080E−11 | 1.65930E−13 | / |
| R6 | −8.04946E+00 | −5.68090E−08 | 1.80710E−09 | −3.19310E−11 | 2.43310E−13 | / |
| R7 | −9.07430E+00 | 3.44520E−08 | −1.00090E−09 | 1.79280E−11 | −1.46710E−13 | / |
| R8 | −1.69697E+01 | 8.53600E−08 | −2.70360E−09 | 4.95220E−11 | −4.02930E−13 | / |
| R9 | −1.30214E+02 | 5.18610E−09 | −3.51160E−10 | 9.99790E−12 | −1.08610E−13 | / |
| R10 | 8.14871E+00 | −1.71370E−09 | 2.12040E−10 | −1.00330E−11 | 1.41080E−13 | / |
| R11 | 1.16028E+01 | 2.00230E−08 | −9.41960E−10 | 2.47300E−11 | −2.79830E−13 | / |
| R12 | −3.21481E+01 | 5.09040E−08 | −3.77780E−09 | 1.62610E−10 | −2.97760E−12 | / |

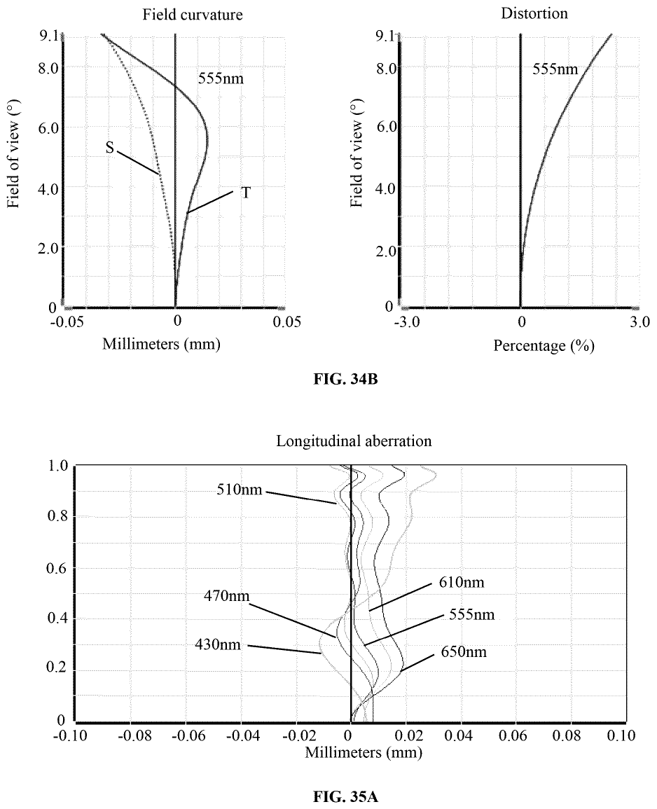

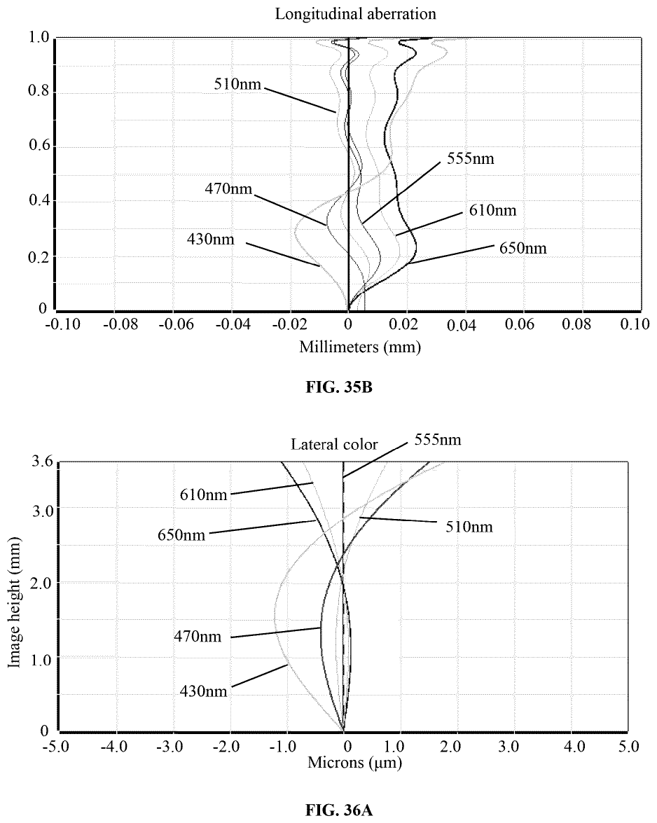

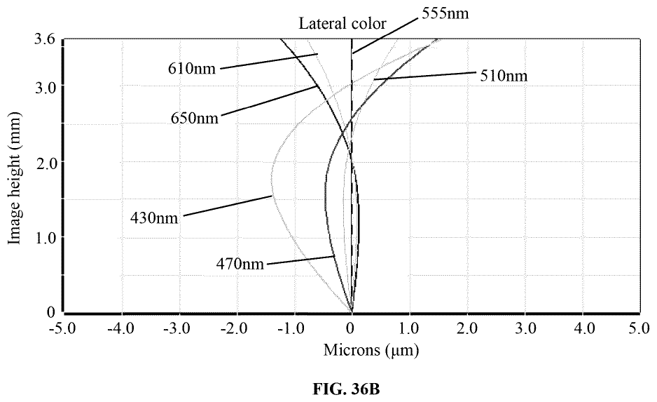

FIG. 34A and FIG. 34B show diagrams illustrating astigmatism field curvatures and distortions after light having a wavelength of 555 nm passes through the camera optical lens 90 of the ninth embodiment. FIG. 35A and FIG. 35B show diagrams illustrating longitudinal aberrations after light having wavelengths of 430 nm, 470 nm, 510 nm, 555 nm, 610 nm, and 650 nm passes through the camera optical lens 90 of the ninth embodiment. FIG. 36A and FIG. 36B show diagrams illustrating lateral colors after light having wavelengths of 430 nm, 470 nm, 510 nm, 555 nm, 610 nm, and 650 nm passes through the camera optical lens 90 of the ninth embodiment.

In this embodiment, for the camera optical lens 90 in the first state, the entrance pupil diameter (ENPD) is 8.318 mm, the full vision field image height IH is 3.600 mm, and the field of view (FOV) is 19.120. The camera optical lens 90 can achieve a large-aperture periscope design with good optical performance. Axial and off-axis chromatic aberrations of the camera optical lens 90 are fully corrected, achieving excellent optical characteristics.

The following Table 28 shows values corresponding to parameters specified in the conditions for each of the first, second, third, fourth, fifth, sixth, seventh, eighth, and ninth embodiments.

TABLE 28

| Parameter and | | | |
|---|---|---|---|
| condition | Embodiment 1 | Embodiment 2 | Embodiment 3 |
| fA/IH | 4.70 | 4.30 | 4.05 |
| Rp1/Rp2 | 0.00 | 0.35 | 0.67 |
| f4/f5 | 0.06 | 0.12 | 0.19 |
| BF/Lp | 0.39 | 0.25 | 0.12 |
| d1/Lp | 0.41 | 0.48 | 0.44 |
| d3/Lp | 0.19 | 0.19 | 0.21 |
| d5/Lp | 0.06 | 0.06 | 0.09 |
| fA | 16.920 | 15.480 | 14.580 |
| fp1 | 99.768 | 83.154 | 119.073 |
| f1 | 13.432 | 12.908 | 13.349 |
| f2 | 5.007 | 4.701 | 4.630 |
| f3 | −3.279 | −3.127 | −3.073 |
| f4 | 24.838 | 24.862 | 23.356 |
| f5 | 413.972 | 207.185 | 122.924 |
| TTL | 40.000 | 40.001 | 38.506 |
| Parameter and | | | |
| condition | Embodiment 4 | Embodiment 5 | Embodiment 6 |
| fA/IH | 4.05 | 6.11 | 5.33 |
| Rp1/Rp2 | 0.73 | −0.03 | −0.55 |
| f4/f5 | 0.16 | −0.16 | −0.32 |
| BF/Lp | 0.62 | 0.42 | 0.85 |
| d1/Lp | 0.19 | 0.49 | 0.29 |
| d3/Lp | 0.27 | 0.11 | 0.31 |
| d5/Lp | 0.09 | 0.06 | 0.04 |
| fA | 14.580 | 22.000 | 19.203 |
| fp1 | 1779.069 | 56.213 | 160.791 |
| f1 | 16.840 | 12.224 | 17.636 |
| f2 | 4.734 | 5.735 | 5.041 |
| f3 | −3.075 | −3.576 | −3.416 |
| f4 | 17.698 | 26.455 | 16.775 |
| f5 | 110.611 | −170.676 | −52.421 |
| TTL | 35.216 | 46.707 | 38.465 |
| Parameter and | | | |
| condition | Embodiment 7 | Embodiment 8 | Embodiment 9 |
| fA/IH | 4.71 | 4.05 | 5.81 |
| Rp1/Rp2 | −1.25 | −2.40 | −3.80 |
| f4/f5 | −0.05 | −0.10 | −0.18 |
| BF/Lp | 0.48 | 0.35 | 0.99 |
| d1/Lp | 0.39 | 0.42 | 0.18 |
| d3/Lp | 0.21 | 0.23 | 0.25 |
| d5/Lp | 0.06 | 0.12 | 0.28 |
| fA | 16.948 | 14.580 | 20.919 |
| fp1 | 113.837 | 146.597 | 103.938 |
| f1 | 13.928 | 14.308 | 22.008 |
| f2 | 5.054 | 4.990 | 5.565 |
| f3 | −3.315 | −3.299 | −3.233 |
| f4 | 23.078 | 21.616 | 12.303 |
| f5 | −461.554 | −216.161 | −68.347 |
| TTL | 40.001 | 39.937 | 37.816 |

It will be understood by those skilled in the art that the embodiments described above are specific embodiments realizing the present disclosure. In practice, various changes may be made to these embodiments in form and in detail without departing from the spirit and scope of the disclosure.

What is claimed is:

1. A camera optical lens, comprising in sequence from an object side to an image side: a first prism with a positive refractive power, a first lens with a positive refractive power, a second lens with a positive refractive power, a third lens with a negative refractive power, a fourth lens with a positive refractive power, and a fifth lens;
wherein a reflective surface is provided between an object-side surface and an image-side surface of the first prism, the first lens, the second lens, the third lens, and the fourth lens form a first lens group, the fifth lens forms a second lens group, the first lens group is movably adjustable along an optical axis of the camera optical lens, enabling the camera optical lens to switch between a first state and a second state;
wherein the camera optical lens has a maximum focal length in the first state and a minimum focal length in the second state, and satisfies the following conditions:
$$4. \leq fA / IH \leq 6.2 ;$$
$$- 4. \leq Rp 1 / Rp 2 \leq 0.75 ;$$
$$- 0.3 \; 5 \leq f 4 / f 5 \leq 0.2 ; and$$
$$0.12 \leq BF / Lp \leq 1. ;$$
wherein:
fA represents a focal length of the camera optical lens in the first state;
IH represents an image height of the camera optical lens;
Rp1 represents a curvature radius of the object-side surface of the first prism;
Rp2 represents a curvature radius of the image-side surface of the first prism;
f4 represents a focal length of the fourth lens;
f5 represents a focal length of the fifth lens;
BF represents a back focal length of the camera optical lens; and
Lp represents a distance from a lens surface closest to the object side to a lens surface closest to the image side on the optical axis of the camera optical lens in the first state.

2. The camera optical lens of claim 1, wherein the camera optical lens further satisfies the following conditions:
$$0.17 \leq d 1 / Lp \leq 0.5 ;$$
$$0.11 \leq d 3 / Lp \leq 0.31 ; and$$
$$0.04 \leq d 5 / Lp \leq 0.3 ;$$
wherein:
d1 represents an on-axis thickness of the first lens;
d3 represents an on-axis thickness of the second lens; and
d5 represents an on-axis thickness of the third lens.

3. The camera optical lens of claim 1, wherein the object-side surface of the first prism is a curved surface and is convex in a paraxial region, and the camera optical lens further satisfies the following conditions:
$$2.55 \leq fp 1 / fA \leq 122.03 ; and$$
$$0.2 \leq dp 1 / TTL \leq 0 \text{.28} ;$$
wherein:
fp1 represents a focal length of the first prism;
dp1 represents a sum of an on-axis distance from the object-side surface of the first prism to the reflective surface and an on-axis distance from the reflective surface to the image-side surface of the first prism; and
TTL represents a total track length of the camera optical lens.

4. The camera optical lens of claim 1, wherein an object-side surface of the first lens is concave in a paraxial region, an image-side surface of the first lens is convex in the paraxial region, and the camera optical lens further satisfies the following conditions:
$$3. 08 \leq ( R 1 + R 2 ) / ( R 1 - R 2 ) \leq 4.5 ;$$
$$0.55 \leq f 1 / fA \leq 1.16 ; and$$
$$0.04 \leq d 1 / TTL \leq 0 \text{.18} ;$$
wherein:
R1 represents a curvature radius of the object-side surface of the first lens;
R2 represents a curvature radius of the image-side surface of the first lens;
f1 represents a focal length of the first lens;
d1 represents an on-axis thickness of the first lens; and
TTL represents a total track length of the camera optical lens.

5. The camera optical lens of claim 1, wherein an object-side surface of the second lens is convex in a paraxial region, an image-side surface of the second lens is convex in the paraxial region, and the camera optical lens further satisfies the following conditions:
$$0.8 \leq ( R 3 + R 4 ) / ( R 3 - R 4 ) \leq 0.96 ;$$
$$0.26 \leq f 2 / fA \leq 0.35 ; and$$
$$0.03 \leq d 3 / TTL \leq 0 \text{.08} ;$$
wherein:
R3 represents a curvature radius of the object-side surface of the second lens;
R4 represents a curvature radius of the image-side surface of the second lens;
f2 represents a focal length of the second lens;
d3 represents an on-axis thickness of the second lens; and
TTL represents a total track length of the camera optical lens.

6. The camera optical lens of claim 1, wherein an object-side surface of the third lens is concave in a paraxial region, an image-side surface of the third lens is concave in the paraxial region, and the camera optical lens further satisfies the following conditions:
$$- 0.35 \leq ( R 5 + R 6 ) / ( R 5 - R 6 ) \leq 0.57 ;$$
$$- 0.2 \; 3 \leq f 3 / fA \leq - 0 \text{.15} ; and$$
$$0.01 \leq d 5 / TTL \leq 0 \text{.08} ;$$
wherein:
R5 represents a curvature radius of the object-side surface of the third lens;
R6 represents a curvature radius of the image-side surface of the third lens;
f3 represents a focal length of the third lens;
d5 represents an on-axis thickness of the third lens; and
TTL represents a total track length of the camera optical lens.

7. The camera optical lens of claim 1, wherein an object-side surface of the fourth lens is convex in a paraxial region, an image-side surface of the fourth lens is convex in the paraxial region, and the camera optical lens further satisfies the following conditions:
$$0.09 \leq ( R 7 + R 8 ) / ( R 7 - R 8 ) \leq 0.93 ;$$
$$0.58 \leq f 4 / fA \leq 1.61 ; and$$
$$0.02 \leq d 7 / TTL \leq 0 \text{.08} ;$$
wherein:
R7 represents a curvature radius of the object-side surface of the fourth lens;
R8 represents a curvature radius of the image-side surface of the fourth lens;
f4 represents a focal length of the fourth lens;
d7 represents an on-axis thickness of the fourth lens; and
TTL represents a total track length of the camera optical lens.

8. The camera optical lens of claim 1, wherein an object-side surface of the fifth lens is convex in a paraxial region, an image-side surface of the fifth lens is concave in the paraxial region, and the camera optical lens further satisfies the following conditions:
$$- 32.34 \leq ( R 9 + R 10 ) / ( R 9 - R 10 ) \leq 1 77.34 ;$$
$$- 27. 24 \leq f 5 / fA \leq 24.47 ; and$$
$$0.15 \leq d 9 / TTL \leq 0 \text{.23} ;$$
wherein:
R9 represents a curvature radius of the object-side surface of the fifth lens;
R10 represents a curvature radius of the image-side surface of the fifth lens;
f5 represents a focal length of the fifth lens;
d9 represents an on-axis thickness of the fifth lens; and
TTL represents a total track length of the camera optical lens.

9. The camera optical lens of claim 1, wherein the first prism is made of glass.
